(19) United States
(12) Patent Application Publication
(10) Pub. No.: US 2005/0239927 A1
(43) Pub. Date: Oct. 27, 2005

(54) Dyeable polyolefin fibers and fabrics

(76) Inventors: Andrew J. Leggio, Franklin Square, NY (US); John J. McNamara, Putnam Valley, NY (US); Jean-Roch Pauquet, Kaiseraugst (CH); Paul Shields, Rivervale, NJ (US); Alessandro Zedda, Basel (CH)

Correspondence Address: JoAnn Villamizar, Patent Department;Ciba Specialty Chemicals Corporation, 540 White Plains Road, P.O. Box 2005, Tarrytown, NY, 10591-9005, US

(21) Appl. No.: 11/107,613

(22) Filed: Apr. 15, 2005

Related U.S. Application Data
(60) Provisional application No. 60/564,831, filed on Apr. 23, 2004.

(51) Int. Cl. C08K 5/34

(52) U.S. Cl. 524/100

(57) ABSTRACT

Polyolefin fibers and filaments, and fabrics made therefrom, are rendered dyeable via a combination of dyeability additives. The dyeability additive combination comprises at least one compound selected from the group consisting of the polyamides, copolyamides and polyetherpolyamides and at least one ethylene vinyl acetate. The dyed polyolefin fibers and fabrics are rendered light stable via the use of a combination of stabilizers, which comprises at least one compound selected from the group consisting of the ultraviolet light stabilizers and at least one compound selected from the group consisting of the hindered amine light stabilizers. The ultraviolet light stabilizers are for example hydroxyphenylbenzotriazoles or tris-aryl-s-triazines. The hindered amine light stabilizers are for example of high molecular weight, for instance greater than 1000 g/mol. The dyes are for example anthraquinone blue dyes, anthraquinone red dyes, diazo red dyes or nitro yellow dyes.

This application claims benefit of U.S. provisional application No. 60/564,831, filed Apr. 23, 2004, the disclosure of which is hereby incorporated by reference.

The present invention relates to olefin polymer fibers and fabrics that exhibit excellent dyeability and lightfastness. The fibers are useful in garments, carpets, upholstery, disposable medical garments, diapers, and the like.

### BACKGROUND

Polyolefins, for example polypropylene, have many advantageous physical properties. However, its inherent ability to be dyed is very poor. There is a long-felt need for dyeable polyolefin compositions that are also light stable, in particular polypropylene fiber.

Most often, colored polypropylene in fiber form is obtained by the addition of solid pigments. Unfortunately, fibers with solid pigment are not nearly as vibrant as dyed fibers. Further, due to their limited number, pigments offer a significantly reduced spectrum of choices as compared to dyes. Likewise, use of pigments restricts the patterns that can be applied to an article of clothing prepared from polypropylene. Certain pigments, additionally, affect the drawability and final properties of the polypropylene fiber. Other polyolefins such as polyethylene possess similar disadvantages. A continuing need exists for dyeable polyolefin compositions, for example polypropylene fibers. A particular need exists for dyeable, light stable polyolefins.

U.S. Pat. No. 5,140,065 discloses pigment compatible thermoplastic molding compositions that comprise a block polyetherpolyamide, a block polyetheresterpolyamide, an amorphous copolyamide and a modified copolyolefin.

U.S. Pat. No. 6,054,215 teaches dyeable polypropylene fibers.

U.S. Pat. No. 5,130,069 discloses dyeable polypropylene fibers that comprise certain polymer additives.

WO 97/47684 discloses polypropylene compositions that show affinity for dispersion dyes that comprise isotactic polypropylene, a copolyamide, and an EVA copolymer.

Surprisingly, it has been found that polyolefin compositions that comprise polyamide/ethylene vinyl acetate dyeability additive blends, at least one ultraviolet light absorber, and at least one hindered amine light stabilizer, are effectively dyed and are light stable.

### SUMMARY OF THE INVENTION

The present invention pertains to a dyed, light stable polyolefin fiber or filament,
which comprises a melt blend which comprises
i) a polyolefin substrate,
ii) an effective amount of a combination of
   at least one dyeability additive compound selected from the group consisting of the polyamides, copolyamides and polyetherpolyamides and
   at least one dyeability additive compound selected from the group consisting of the ethylene vinyl acetate copolymers and
iii) an effective amount of a combination of
   at least one additive compound selected from the group consisting of the ultraviolet light absorbers and
   at least one additive compound selected from the group consisting of the hindered amine light stabilizers
and which fiber or filament further comprises at least one disperse dye.

The present invention also pertains to a method of preparing a dyed, light stable polyolefin fiber or filament,
which method comprises
melt blending a composition comprising
i) a polyolefin substrate,
ii) an effective amount of a combination of
   at least one dyeability additive compound selected from the group consisting of the polyamides, copolyamides and polyetherpolyamides and
   at least one dyeability additive compound selected from the group consisting of the ethylene vinyl acetate copolymers and
iii) an effective amount of a combination of
   at least one compound selected from the group consisting of the ultraviolet light absorbers and
   at least one compound selected from the group consisting of the hindered amine light stabilizers,
and which method further comprises treating said melt blend with at least one disperse dye.

### DETAILED DISCLOSURE

Examples for polyolefin substrates are:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, for example polyethylene and polypropylene, can be prepared by different, and especially by the following, methods:
i) radical polymerization (normally under high pressure and at elevated temperature).
ii) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1.), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

Polyolefins of the present invention are for example polypropylene homo- and copolymers and polyethylene homo- and copolymers. For instance, polypropylene, high density polyethylene (HDPE), linear low density polyethylene (LLDPE) and polypropylene random and impact copolymers.

It is within the purview of the present invention to employ blends or alloys of olefin polymers.

The dyeability additives of this invention are a combination of at least one compound selected from the group consisting of the polyamides, copolyamides and polyetherpolyamides with at least one compound selected from the group consisting of the ethylene vinyl acetate copolymers.

The polyamides and copolyamides are those for example disclosed in WO 97/47684 and U.S. Pat. No. 5,130,069, the disclosure of which is hereby incorporated by reference. The present polyamides and copolyamides are for example of low crystallinity.

The polyamides are those prepared by the polymerization of a monoamino-monocarboxylic acid or a lactam thereof having at least 2 carbon atoms between the amino and carboxylic acid group, of substantially equimolar proportions of a diamine which contains at least 2 carbon atoms between the amino groups and a dicarboxylic acid, or of a monoaminocarboxylic acid or a lactam thereof as defined above together with substantially equimolar proportions of a diamine and a dicarboxylic acid. The term “substantially equimolar” proportions includes both strictly equimolar proportions and slight departures therefrom which are involved in conventional techniques for stabilizing the viscosity of the resultant polyamides. The dicarboxylic acid may be used in the form of a functional derivative thereof, for example, an ester or acid chloride.

Examples of the aforementioned monoamino-monocarboxylic acids or lactams thereof which are useful in preparing the polyamides include those compounds containing from 2 to 16 carbon atoms between the amino and carboxylic acid groups, said carbon atoms forming a ring containing the —CO—NH— group in the case of a lactam. As particular examples of aminocarboxylic acids and lactams there may be mentioned ε-aminocaproic acid, butyrolactam, pivalolactam, ε-caprolactam, capryllactam, enantholactam, undecanolactam, dodecanolactam and 3- and 4-aminobenzoic acids.

Diamines suitable for use in the preparation of the polyamides include the straight chain and branched chain alkyl, aryl and alkaryl diamines. Illustrative diamines are trimethylenediamine, tetramethylenediamine, pentamethylenediamine, octamethylenediamine, hexamethylenediamine (which is often preferred), trimethylhexamethylenediamine, m-phenylenediamine and m-xylylenediamine.

The dicarboxylic acids may be represented by the formula
HOOC—B—COOH
wherein
B is a divalent aliphatic or aromatic group containing at least 2 carbon atoms. Examples of aliphatic acids are sebacic acid, octadecanedioic acid, suberic acid, glutaric acid, pimelic acid and adipic acid.

Both crystalline and amorphous polyamides may be employed, with the crystalline species often being preferred by reason of their solvent resistance. Typical examples of the polyamides or nylons, as these are often called, include, for example, polyamide-6 (polycaprolactam), 6,6 (polyhexamethylene adipamide), 11, 12, 4,6, 6,10 and 6,12 as well as polyamides from terephthalic acid and/or isophthalic acid and trimethylhexamethylenediamine; from adipic acid and m-xylylenediamines; from adipic acid, azelaic acid and 2,2-bis(p-aminophenyl)propane or 2,2-bis-(p-aminocyclohexyl)propane and from terephthalic acid and 4,4′-diaminodicyclohexylmethane. Mixtures and/or copolymers of two or more of the foregoing polyamides or prepolymers thereof, respectively, are also within the scope of the present invention. Preferred polyamides are polyamide-6, 4,6, 6,6, 6,9, 6,10, 6,12, 11 and 12, most preferably polyamide-6,6.

Polyamides may be obtained by the ring opening polymerization or polycondensation of the polyamide forming components in the presence of a molecular weight modifier. As molecular weight modifier dicarboxylic acids with from 4 to 20 carbons are usually used, more specifically aliphatic dicarboxylic acids such as succinic acid, glutaric acid, adipic acid, pimelic acid, suberic acid, azelaic acid, sebacic acid, undecane dicarboxylic acid and dodecane dicarboxylic acid; aromatic dicarboxylic acids such as terephthalic acid, isophthalic acid, phthalic acid, naphthalene dicarboxylic acid and 3-sulfoisophthalic acid alkali metal salt; and alicyclic dicarboxylic acids such as 1,4-cyclohexane dicarboxylic acid, dicyclohexyl-4,4′-dicarboxylic acid. Halogeno or sulfoxyl derivatives of these carboxylic acids are also used. Examples among these compounds are aliphatic dicarboxylic acids and aromatic dicarboxylic acids, more preferable are adipic acid, sebacic acid, terephthalic acid, isophthalic acid and 3-sulfoisophthalic acid alkali metal salt.

The copolyamides consist of the polycondensation products of the above polyamides.

The copolyamide component is obtained by polycondensation of a suitable monomer mixture, preferably a monomer mixture containing a considerable part, for example, more than about 10% by weight, preferably about 20 to about 40% by weight, units with a linear aliphatic chain with from 8 to 12 carbon atoms, preferably 12 carbon atoms, and which does not comprise any important quantities of ionic groups. These copolyamides are commercially available. Typical copolyamides, suitable as component for the compositions of this invention, are for example, polyamides (PA) of the nylon type which are the polycondensation product of monomer mixtures PA6/PA6,6/PA12 with a composition (by weight) of 40:20:40 or 40:40:20.

For instance, the copolyamides comprise the polycondensation products of at least two compounds selected from the group consisting of lactams of 6 to 12 carbon atoms and aminocarbonic acids of 6 to 12 carbon atoms, and equimolar quantities of a diamine of 4 to 12 carbon atoms and a diprimary carbonic acid of 6 to 36 carbon atoms.

For instance, the copolyamides comprise the polycondensation products of about 20 to about 90% by weight, based on the copolyamide, of at least one lactam or aminocarbonic acid (for example linear and aliphatic) of 6 to 12 carbon atoms and about 80 to about 10% by weight, based on the copolyamide of equimolar quantities of a diamine of 4 to 12 carbon atoms and a diprimary carbonic acid of 6 to 36 carbon atoms.

For example, the quantity of lactam or aminocarbonic acid in the copolyamide is from about 20 to about 60% by weight, based on the copolyamide.

For example, the copolyamide comprises the polycondensation products of from about 20 to about 90% by weight of at least two cyclolactams or at least two aminocarbonic acids, and from about 80 to about 10% by weight of equimolar quantities of a diamine and a dicarbonic acid, based on the weight of the copolyamide.

For instance, the copolyamide comprises the polycondensation products of from about 20 to about 90% by weight of at least one lactam or aminocarbonic acid and from about 80 to about 10% by weight of equimolar quantities of a piperazine and a dicarbonic acid of 6 to 36 carbon atoms.

The diamine in the copolyamide component may be diprimary amine or a disecondary amine, for example piperazine.

The copolyamide component for example consists of a copolyamide wherein the quantity of the lactam or carbonic acid component is about 20% to about 60% by weight based on the copolymer, and wherein the lactam or carbonic acid components comprises a mixture of at least 2 cyclolactams or linear aliphatic aminocarbonic acids.

For example, in the present copolyamides, the lactam or carbonic acid component contains from about 15% to about 60%, based on the copolyamide, of 11-aminoundecanoic acid and/or 12-aminododecanoic acid.

For instance, the present copolyamide component contains piperazine groups.

The copolyamide component preferable has a relative viscosity, η rel, of 1,4 to 1,9, measured according to DIN 53727 (m-cresole; c=0, 25 g/50 mL; Ubbelohde viscosity meter; capillary II; 25° C.).

The molecular weight distribution of the copolyamides in which the individual polyamide segments may be present as well in ordered form as in a random order, does not have as essential influence upon the dyeability and only a relatively small influence upon the processability of the formulations.

The suitable copolyamides are commercially available.

The present copolyamides may be as described in U.S. Pat. No. 5,130,069, the relevant disclosure of which is hereby incorporated by reference.

The present polyetherpolyamides are the products formed from the polycondensation of polyetherdiamines, dicarboxylic acids, dimeric acids and from lactams, for example caprolactam. The polyetherpolyamides are for example block copolymers. For instance, a present polyetherpolyamide is formed from the polycondensation of caprolactam, a dimeric acid and a polyetherdiamine such as Jeffamine D-2000.

The present polyetherpolyamides are disclosed for example in U.S. Pat. Nos. 5,140,065 and 4,356,300, the relevant discosure of which is hereby incorporated by reference.

The present ethylene vinyl acetate copolymer for example has a MFR (melt flow rate) vale of about 3 to about 8 g/10 min at 190° C. and at a pressure of 21.2 N (2.16 kg), measured according to ISO 1133, a density of about 0.93 to about 0.96 g/cm³, measured according to DIN 53455, and a VICAT point of about 35 to about 65° C., measured according to DIN 53460.

Suitable ethylene vinyl acetate (EVA) copolymers are those which comprise from about 18% to about 33% vinyl acetate, or from about 27% to about 29% vinyl acetate, by weight, based on the weight of the EVA, and/or have a MFR value of about 5 to about 8 g/10 min as described above.

The weight:weight ratio of the dyeability additives to the polyolefin component in the compositions of the present invention is from about 0.1:99.9 to about 40:60. For many applications, the dyeability additives are present from about 0.1% to about 15% by weight, based on the weight of the polyolefin component, for example from about 0.5% to about 10% by weight based on the weight of the polyolefin component. For instance, the dyeability additives are present from about 7% to about 9%, or about 8% by weight, based on the weight of the polyolefin.

The weight:weight ratio of the additive or additives selected from the group consisting of the polyamides, copolyamides and polyetherpolyamides to the ethylene vinyl acetate copolymer is from about 1:9 to about 9:1, for example from about 1:7 to about 7:1, from about 1:5 to about 5:1, or from about 1:3 to about 3:1.

The present ultraviolet light absorbers (UVAs) are selected from the group consisting of the hydroxyphenylbenzotriazoles, the benzophenones, the α-cyanoacrylates, the oxanilides, the tris-aryl-s-triazines, the cinnamates, the malonates, the benzoates and the salicylates.

For example, the present UVAs are selected from the group consisting of the hydroxyphenylbenzotriazoles, the benzophenones and the tris-aryl-s-triazines.

For instance, the present UVAs are selected for the group consisting of the hydroxyphenylbenzotriazoles and the tris-aryl-s-triazines.

The present hydroxyphenylbenzotriazole UV absorbers are disclosed for example in U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987 and 5,977,219, the disclosure of which are hereby incorporated by reference.

The present tris-aryl-s-triazine UV absorbers are discosed for example in U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, the disclosures of which are hereby incorporated by reference.

Examples of the UV absorbers useful in the instant invention are
4-octyloxy-2-hydroxybenzophenone,
4-methoxy-2-hydroxybenzophenone,
2-(2-hydroxy-5-methylphenyl)-2H-benzotriazole,
2-(2-hydroxy-5-tert-octylphenyl-2H-benzotriazole,
2-(2-hydroxy-3,5-di-tert-amylphenyl)-2H-benzotriazole,
octyl 3-(benzotriazol-2-yl)-5-tert-butyl-4-hydroxyhydrocinnamate,
2-(2-hydroxy-3,5-di-tert-butylphenyl)-2H-benzotriazole,
2-(2-hydroxy-5-tert-butylphenyl)-2H-benzotriazole,
5-chloro-2-(2-hydroxy-3,5-di-tert-butylphenyl)-2H-benzotriazole,
5-chloro-2-(2-hydroxy-3-tert-butyl-5-methylphenyl)-2H-benzotriazole,
2-(2-hydroxy-3-sec-butyl-5-tert-butylphenyl)-2H-benzotriazole,
2-(2-hydroxy-4-octyloxyphenyl)-2H-benzotriazole,
2-(2-hydroxy-3-dodecyl-5-methylphenyl)-2H-benzotriazole,
2-[2-hydroxy-3,5-di(α,α-dimethylbenzyl)phenyl]-2H-benzotriazole,
2-[2-hydroxy-3-(α,α-dimethylbenzyl)-5-tert-octylphenyl]-2H-benzotriazole,
2-{2-hydroxy-3-tert-butyl-5-[2-(omega-hydroxy-octa(ethyleneoxy)carbonyl)ethyl]phenyl}-2H-benzotriazole,
2-{2-hydroxy-3-tert-butyl-5-[2-(octyloxy)carbonyl)ethyl]phenyl}-2H-benzotriazole,
2-ethylhexyl p-methoxycinnamate,
4-methoxy-2,2′-dihydroxybenzophenone,
4,4′-dimethoxy-2,2′-dihydroxybenzophenone,
2,4-bis(2,4-dimethylphenyl)-6-(2-hydroxy-4-octyloxyphenyl)-s-triazine,
2,4-diphenyl-6-(2-hydroxy-4-hexyloxyphenyl)-s-triazine,
2,4-bis(2,4-dimethylphenyl)-6-[2-hydroxy-4-(3-do-/tri-decyloxy-2-hydroxypropoxy)phenyl]-s-triazine,
2,4-bis(2,4-dimethylphenyl)-6-[2-hydroxy-4-(3-do-/tri-decyloxy-2-hydroxypropoxy)-5-α-cumylphenyl]-s-triazine and
the reaction product of 2,4,6-tris(2,4-dihydroxyphenyl)-s-triazine with octyl α-haloacetate.

For example, UV absorbers useful in the instant invention are
4-octyloxy-2-hydroxybenzophenone,
4-methoxy-2-hydroxybenzophenone,
2-(2-hydroxy-5-tert-octylphenyl-2H-benzotriazole,
2-[2-hydroxy-3-(α,α-dimethylbenzyl)-5-tert-octylphenyl]-2H-benzotriazole,
5-chloro-2-(2-hydroxy-3,5-di-tert-butylphenyl)-2H-benzotriazole,
2-{2-hydroxy-3-tert-butyl-5-[2-(omega-hydroxy-octa(ethyleneoxy)carbonyl)ethyl]phenyl}-2H-benzotriazole,
2-{2-hydroxy-3-tert-butyl-5-[2-(octyloxy)carbonyl)ethyl]phenyl}-2H-benzotriazole,
2,4-diphenyl-6-(2-hydroxy-4-hexyloxyphenyl)-s-triazine,
2,4-bis(2,4-dimethylphenyl)-6-[2-hydroxy-4-(3-do-/tri-decyloxy-2-hydroxypropoxy)phenyl]-s-trizine or
the reaction product of 2,4,6-tris(2,4-dihydroxyphenyl)-s-triazine with octyl α-haloacetate.

For example, the present UVAs are 5-chloro-2-(2-hydroxy-3,5-di-tert-butylphenyl)-2H-benzotriazole or 2,4-diphenyl-6-(2-hydroxy-4-hexyloxyphenyl)-s-triazine.

The hindered amine light stabilizers (HALS) are selected from the group consisting of hindered amines substituted on the N-atom by an alkoxy or cycloalkoxy moiety, hindered amines substituted on the N-atom by an alkoxy which is further substituted with an hydroxy group, and conventional hindered amines where the N-atom is substituted by hydrogen, alkyl, acyl and the like.

The hindered amine light stabilizers are disclosed for example in U.S. Pat. Nos. 5,204,473, 5,980,783, 6,046,304, 6,297,299, 5,844,026 and 6,271,377, the disclosures of which are hereby incorporated by reference.

Alkoxy is a branched or straight chain radical having up to 25 carbon atoms, for example methoxy, ethoxy, propoxy, isopropoxy, n-butoxy, isobutoxy, pentyloxy, isopentyloxy, hexyloxy, heptyloxy, octyloxy, decyloxy, tetradecyloxy, hexadecyloxy or octadecyloxy. Present alkoxy may have from 1 to 12, for instance from 1 to 8, e.g. from 1 to 6, carbon atoms.

Cycloalkoxy is for example C₅-C₁₂cycloalkoxy, for example cyclopentyloxy or cyclohexyloxy.

Alkyl is a branched or straight chain radical having up to 25 carbon atoms, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl.

The hindered amines substituted on the N-atom by an alkoxy or a cycloalkoxy moiety are well known in the art. These are described in detail in U.S. Pat. No. 5,204,473, the relevant parts of which are incorporated herein by reference.

The hindered amines substituted on the N-atom by an alkoxy, cycloalkoxy or benzyloxy moiety which are useful in the instant invention include the following:
bis(1-octyloxy-2,2,6,6-tetramethylpiperidin-4-yl)sebacate;
bis(1-cyclohexyloxy-2,2,6,6-tetramethylpiperidin-4-yl)sebacate;
1-cyclohexyloxy-2,2,6,6-tetramethyl-4-octadecylaminopiperidine;
2,4-bis[(1-cyclohexyloxy-2,2,6,6-tetramethylpiperidin-4-yl)butylamino]-6-(2-hydroxyethyl-amino-s-trazine;
bis(1-cyclohexyloxy-2,2,6,6-tetramethylpiperidin-4-yl)adipate;
the oligomeric compound which is the condensation product of 4,4′-hexamethylene-bis(amino-(1-octyloxy-2,2,6,6-tetramethylpiperidine) and 2,4-dichloro-6-[(1-octyloxy-2,2,6,6-tetramethylpiperidin-4-yl)butylamino]-s-triazine end-capped with 2-chloro4,6-bis(dibutylamino)-s-triazine;
the oligomeric compound which is the condensation product of 4,4′-hexamethylene-bis(amino-(1-cyclohexyloxy-2,2,6,6-tetramethylpiperidine)) and 2,4-dichloro-6-[(1-cyclohexyloxy-2,2,6,6-tetramethylpiperidin-4-yl)butylamino]-s-triazine end-capped with 2-chloro-4,6-bis(dibutyl-amino)-s-triazine;
the oligomeric compound which is the condensation product of 4,4′-hexamethylene-bis(amino-(1-propyloxy-2,2,6,6-tetramethylpiperidine)) and 2,4-dichloro-6-[(1-propyloxy-2,2,6,6-tetramethylpiperidin-4-yl)butylamino]-s-triazine end-capped with 2-chloro-4,6-bis(dibutylamino)-s-triazine (the n-propoxy derivative of the corresponding N—H hindered amine below);
the oligomeric compound which is the condensation product of 4,4′-hexamethylene-bis(amino-(1-acetoyloxy-2,2,6,6-tetramethylpiperidine)) and 2,4-dichloro-6-[(1-acetoyloxy-2,2,6,6-tetramethylpiperidin-4-yl)butylamino]-s-triazine end-capped with 2-chloro-4,6-bis(dibutyl-amino)-s-triazine;
1-methoxy-4-hydroxy-2,2,6,6-tetramethylpiperidine;
1-octyloxy-4-hydroxy-2,2,6,6-tetramethylpiperidine;
1-cyclohexyloxy-4-hydroxy-2,2,6,6-tetramethylpiperidine;
1-methoxy-4-oxo-2,2,6,6-tetramethylpiperidine;
1-octyloxy-4-oxo-2,2,6,6-tetramethylpiperidine;
1-cyclohexyloxy-4-oxo-2,2,6,6-tetramethylpiperidine;
bis(1-heptyloxy-2,2,6,6-tetramethylpiperidin-4-yl)sebacate;
bis(1-nonyloxy-2,2,6,6-tetramethylpiperidin-4-yl)sebacate;
bis(1-dodecyloxy-2,2,6,6-tetramethylpiperidin-4-yl)sebacate;
N,N′,N″,N′″-tetrakis[(4,6-bis(butyl-1-octyloxy-2,2,6,6-pentamethylpiperidin-4-yl)-amino-s-triazin-2-yl]-1,10-diamino-4,7-diazadecane; and

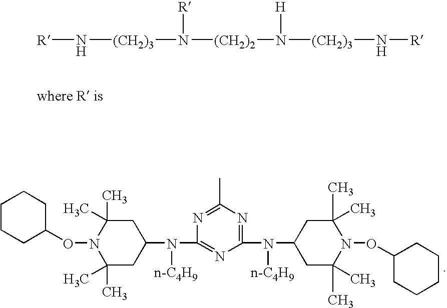

This specific hydrocarbyloxy hindered amine stabilizer, CAS # 191680-81-6, is described in U.S. Pat. No. 5,844,026.

The hindered amines substituted on the N-atom by a hydroxy-substituted alkoxy group are disclosed in U.S Pat. No. 6,271,377, the relevant parts of which are also incorporated herein by reference.

The hindered amines substituted on the N-atom by a hydroxy-substituted alkoxy moiety which are useful in the instant invention include the following:
1-(2-hydroxy-2-methylpropoxy)-4-octadecanoyloxy-2,2,6,6-tetramethylpiperidine;
1-(2-hydroxy-2-methylpropoxy)-4-hydroxy-2,2,6,6-tetramethylpiperidine;
1-(2-hydroxy-2-methylpropoxy)-4-oxo-2,2,6,6-tetramethylpiperidine;
bis(1-(2-hydroxy-2-methylpropoxy)-2,2,6,6-tetramethylpiperidin-4-yl)sebacate;
bis(1-(2-hydroxy-2-methylpropoxy)-2,2,6,6-tetramethylpiperidin-4-yl)adipate;
bis(1-(2-hydroxy-2-methylpropoxy)-2,2,6,6-tetramethylpiperidin-4-yl)succinate;
bis(1-(2-hydroxy-2-methylpropoxy)-2,2,6,6-tetramethylpiperidin-4-yl)glutarate; and
2,4-bis{N-[1-(2-hydroxy-2-methylpropoxy)-2,2,6,6-tetramethylpiperidin-4-yl]-N-butyl-amino}-6-(2-hydroxyethylamino)-s-triazine.

Conventional hindered amines useful in the present invention include the following:
the oligomeric compound which is the condensation product of 4,4′-hexamethylene-bis(amino-(2,2,6,6-tetramethylpiperidine)) and 2,4-dichloro-6-[(2,2,6,6-tetramethylpiperidin-4-yl)butylamino]-s-triazine end-capped with 2-chloro-4,6-bis(dibutylamino)-s-triazine;
bis(2,2,6,6-tetramethylpiperidin-4-yl)sebacate;
polycondensation product of 2,4-dichloro-6-tert-octylamino-s-triazine and 4,4′-hexa-methylenebis(amino-2,2,6,6-tetramethylpiperidine);
polycondensation product of 1-(2-hydroxyethyl)-2,2,6,6-tetramethyl-4-hydroxypiperidine and succinic acid;
polycondensation product of 4,4′-hexamethylenebis-(amino-2,2,6,6-tetramethyl-piperidine) and 1,2-dibromoethane;
mixture of bis(2,2,6,6-tetramethylpiperidin-4-yl)sebacate and the polycondensation product of 2,4-dichloro-6-tert-octylamino-s-triazine and 4,4′-hexamethylenebis(amino-2,2,6,6-tetramethylpiperidine);
mixture of the polycondensation product of 1-(2-hydroxyethyl)-2,2,6,6-tetramethyl-4-hydroxypiperidine and succinic acid with the polycondensation product of 2,4-dichloro-6-tert-octylamino-s-triazine and 4,4′-hexamethylenebis(amino-2,2,6,6-tetramethylpiperidine);
bis(1,2,2,6,6-pentamethylpiperidin-4-yl)sebacate;
di(1,2,2,6,6-pentamethylpiperidin-4-yl) (3,5-di-tert-butyl-4-hydroxybenzyl)butylmalonate;
4-benzoyl-2,2,6,6-tetramethylpiperidine;
4-stearyloxy-2,2,6,6-tetramethylpiperidine;
tris(2,2,6,6-tetramethylpiperidin-4-yl)nitrilotriacetate;
tetrakis(2,2,6,6-tetramethylpiperidin-4-yl)1,2,3,4-butanetetracarboxylate;
tetrakis(1,2,2,6,6-pentamethylpiperidin-4-yl)1,2,3,4-butanetetracarboxylate;
polycondensation product of 2,4-dichloro-6-morpholino-s-triazine and 4,4′-hexa-methylenebis(amino-2,2,6,6-tetramethylpiperidine);
polycondensation product of 2,4-dichloro-6-morpholino-s-triazine and 4,4′-hexa-methylenebis(amino-(1-methyl-2,2,6,6-tetramethylpiperidine));
N,N′,N″,N′″-tetrakis[(4,6-bis(butyl-1,2,2,6,6-pentamethylpiperidin-4-yl)-amino-s-triazin-2-yl-]-1,10-diamino-4,7-diazadecane;
octamethylene bis(2,2,6,6-tetramethylpiperidin-4-carboxylate);
N-2,2,6,6-tetramethylpiperidin-4-yl-n-dodecylsuccinimide;
N-1,2,2,6,6-pentamethylpiperidin-4-yl-n-dodecylsuccinimide;
N-1-acetyl-2,2,6,6-tetramethylpiperidin4-yln-dodecylsuccinimide;
4-C₁₅-C₁₇alkanoyloxy-2,2,6,6-tetramethylpiperidine;
polycondensation product of 2,4-dichloro-6-cyclohexylamino-s-triazine and 4,4′-hexa-methylenebis(amino-2,2,6,6-tetramethylpiperidine);
1,5-bis(2,2,6,6-tetramethylpiperidin-4-yl)-1,5-diaza-4-oxopropane;
copolymer of methyl methracrylate, ethyl acrylate and 2,2,6,6-tetramethylpiperidin-4-yl acrylate;
copolymer of N-octadecylmaleimide, styrene and N-(2,2,6,6-tetramethylpiperidin-4yl)maleimide;
1,3,5-tris[3-(2,2,6,6-piperidin-4-ylamino)-2-hydroxy-propyl)isocyanurate;
olefin copolymer containing units derived from N-[2-(2,2,6,6-tetramethylpiperidin-4-yl)-oxalamid-1-yl]maleimide;
2,2,4,4-tetramethyl-7-oxa-3,20-diaza-21-oxo-dispiro[5,1,11,2]heneicosane;
C₁₂-C₁₄alkyl 3-(2,2,4,4-tetramethyl-7-oxa-3,20-diaza-21-oxo-dispiro[5,1,11,2]henecosane-20-yl)propionate;
reaction product of epichlorohydrin and 2,2,4,4-tetramethyl-7-oxa-3,20-diaza-21-oxo-dispiro[5,1,11,2]heneicosane;
1,3-di(2,2,6,6-tetramethylpiperidin-4-yl)2,4-ditridecyl butanetetracarboxylate;
1,3-di(1,2,2,6,6-pentamethylpiperidin-4-yl)2,4-ditridecyl butanetetracarboxylate;
polycondensation product of 3,9-bis(1,1-dimethyl-2-hydroxyethyl)-2,4,8,10-tetraoxaspiro-[5.5]undecane, tetramethyl 1,2,3,4-butanetetra-carboxylate and 2,2,6,6-tetramethyl-4-hydroxy-piperidine;
polycondensation product of 3,9-bis(1,1-dimethyl-2-hydroxyethyl)-2,4,8,10-tetraoxaspiro-[5.5]undecane, tetramethyl 1,2,3,4-butanetetra-carboxylate and 1,2,2,6,6-pentamethyl-4-hydroxypiperidine;
1,4-bis(2,2,6,6-tetramethylpiperidin-4-yl)-2,2-dimethyl-1,4-diaza4-oxopropane;
reaction product of 4-amino-2,2,6,6-tetramethylpiperidine and tetramethylolacetylene-diurea;
1,6-hexamethylenebis[N-formyl-N-(2,2,6,6-tetramethylpiperidin-4-yl)amine];
copolymer of N-(2,2,6,6-tetramethylpiperdin-4-yl)maleimide and a C₂₀-C₂₄-alpha-olefin;
poly[3-(2,2,6,6-tetramethylpiperidin-4-yloxy)propyl-methyl-siloxane];
polycondensation product of 2,4-dichloro-6-[N-butyl-N-(2,2,6,6-tetramethylpiperidin-4-yl)amino]-s-triazine and 1,10-diamino-4,7-diazadecane;
dodecyl 3-(2,2,4,4-tetramethyl-7-oxa-3,20-diaza-21-oxo-dispiro[5,1,11,2]heneicosane-20-yl)propionate;

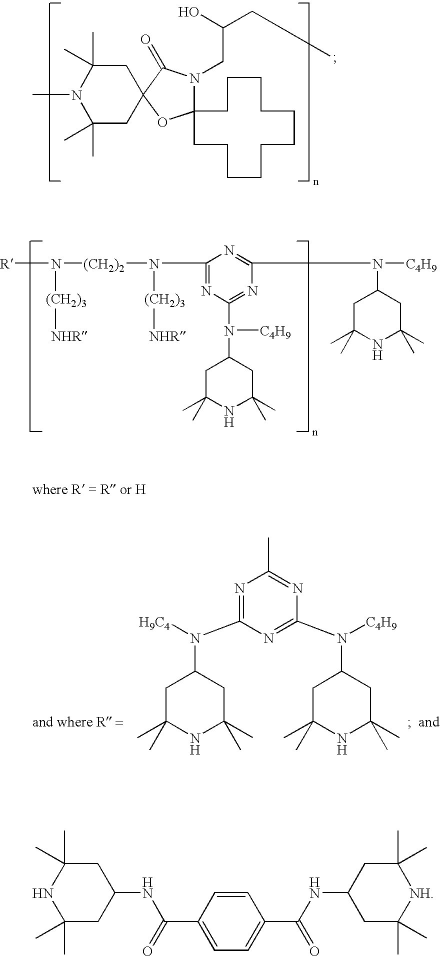

For instance, the hindered amines useful in the present invention include:
the oligomeric compound which is the condensation product of 4,4′-hexamethylene-bis(amino-(1-propyloxy-2,2,6,6-tetramethylpiperidine)) and 2,4-dichloro-6-[(1-propyloxy-2,2,6,6-tetramethylpiperidin-4-yl)butylamino]-s-triazine end-capped with 2-chloro-4,6-bis(dibutylamino)-s-triazine (CAS# 247243-62-5); 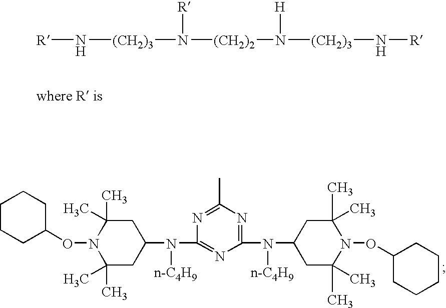
the oligomeric compound which is the condensation product of 4,4′-hexamethylene-bis(amino-(2,2,6,6-tetramethylpiperidine)) and 2,4-dichloro-6-[(2,2,6,6-tetramethylpiperidin-4-yl)butylamino]-s-triazine end-capped with 2-chloro-4,6-bis(dibutylamino)-s-triazine;
bis(2,2,6,6-tetramethylpiperidin-4-yl)sebacate;
polycondensation product of 2,4-dichloro-6-tert-octylamino-s-triazine and 4,4′-hexa-methylenebis(amino-2,2,6,6-tetramethylpiperidine);
polycondensation product of 1-(2-hydroxyethyl)-2,2,6,6-tetramethyl-4-hydroxypiperidine and succinic acid;
mixture of bis(2,2,6,6-tetramethylpiperidin-4-yl)sebacate and the polycondensation product of 2,4-dichloro-6-tert-octylamino-s-triazine and 4,4′-hexamethylenebis(amino-2,2,6,6-tetramethylpiperidine);
mixture of the polycondensation product of 1-(2-hydroxyethyl)-2,2,6,6-tetramethyl-4-hydroxypiperidine and succinic acid with the polycondensation product of 2,4-dichloro-6-tert-octylamino-s-triazine and 4,4′-hexamethylenebis(amino-2,2,6,6-tetramethylpiperidine);
bis(1,2,2,6,6-pentamethylpiperidin-4-yl)sebacate;
di(1,2,2,6,6-pentamethylpiperidin-4-yl)(3,5-di-tert-butyl-4-hydroxybenzyl)butylmalonate;
polycondensation product of 2,4-dichloro-6-morpholino-s-triazine and 4,4′-hexa-methylenebis(amino-2,2,6,6-tetramethylpiperidine);
polycondensation product of 2,4-dichloro-6-morpholino-s-triazine and 4,4′-hexa-methylenebis(amino-(1-methyl-2,2,6,6-tetramethylpiperidine));
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane;

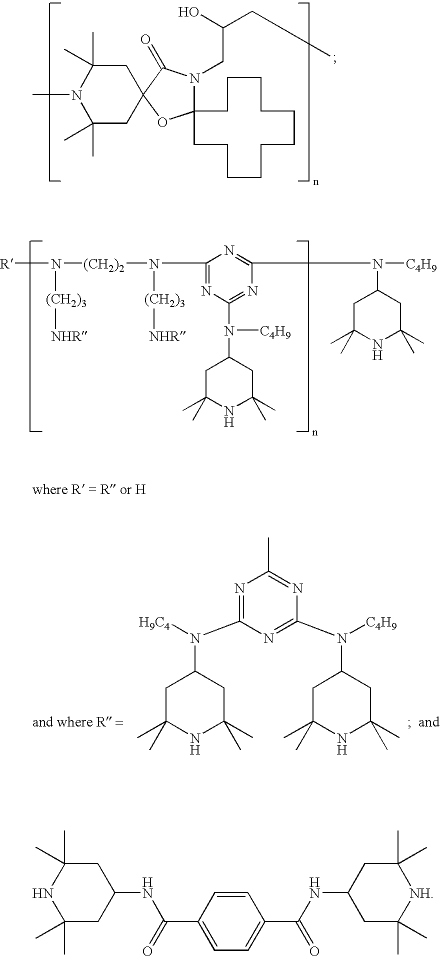

The present oligomeric hindered amines and “polycondesation” product hindered amines have molecular weights greater than about 1000 g/mole. Certain non-oligomeric hindered amines also have molecular weights greater than about 1000 g/mol. These high molecular weight hindered amines are particularly advantageous.

For example, the present hindered amines are selected from the group consisting of 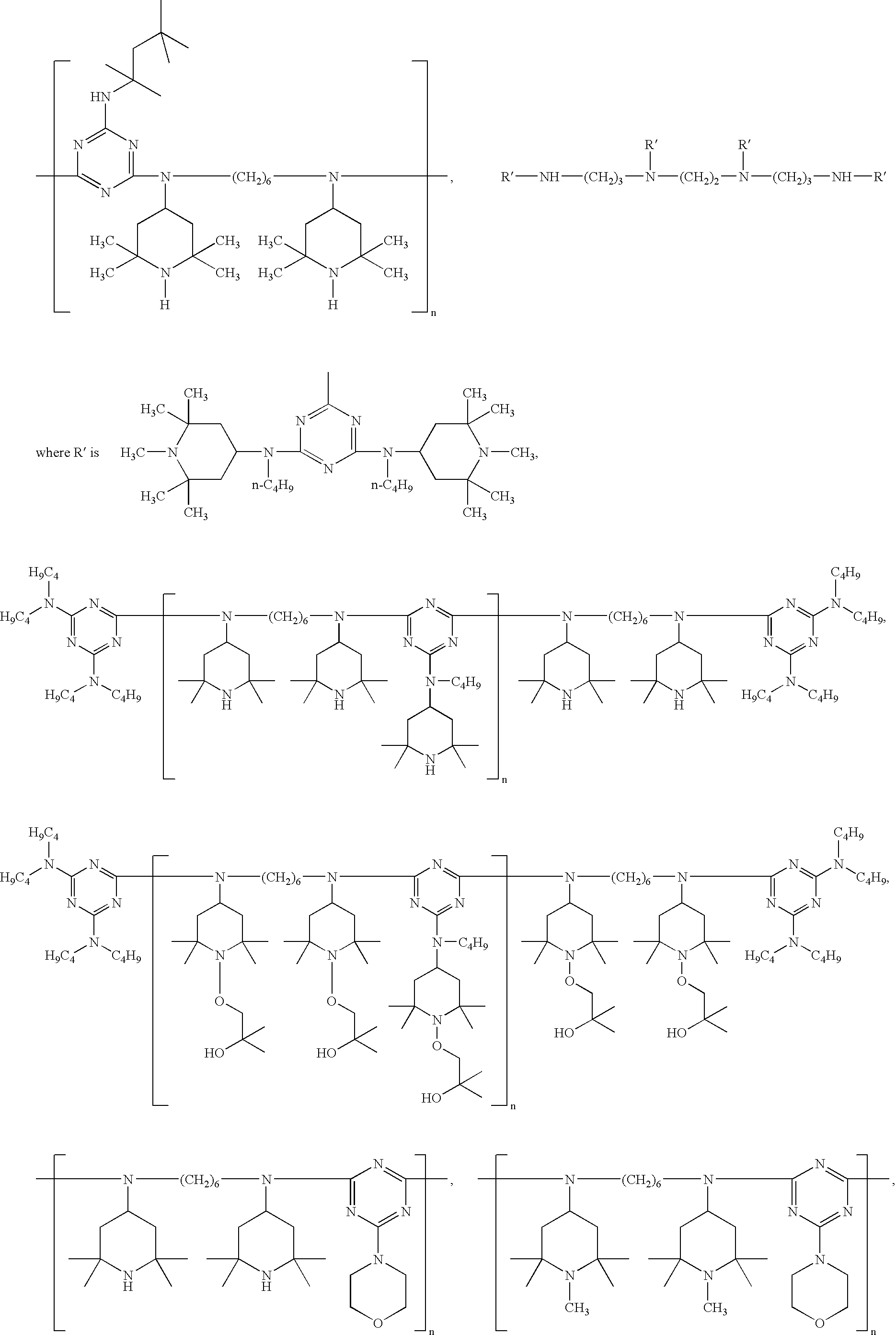 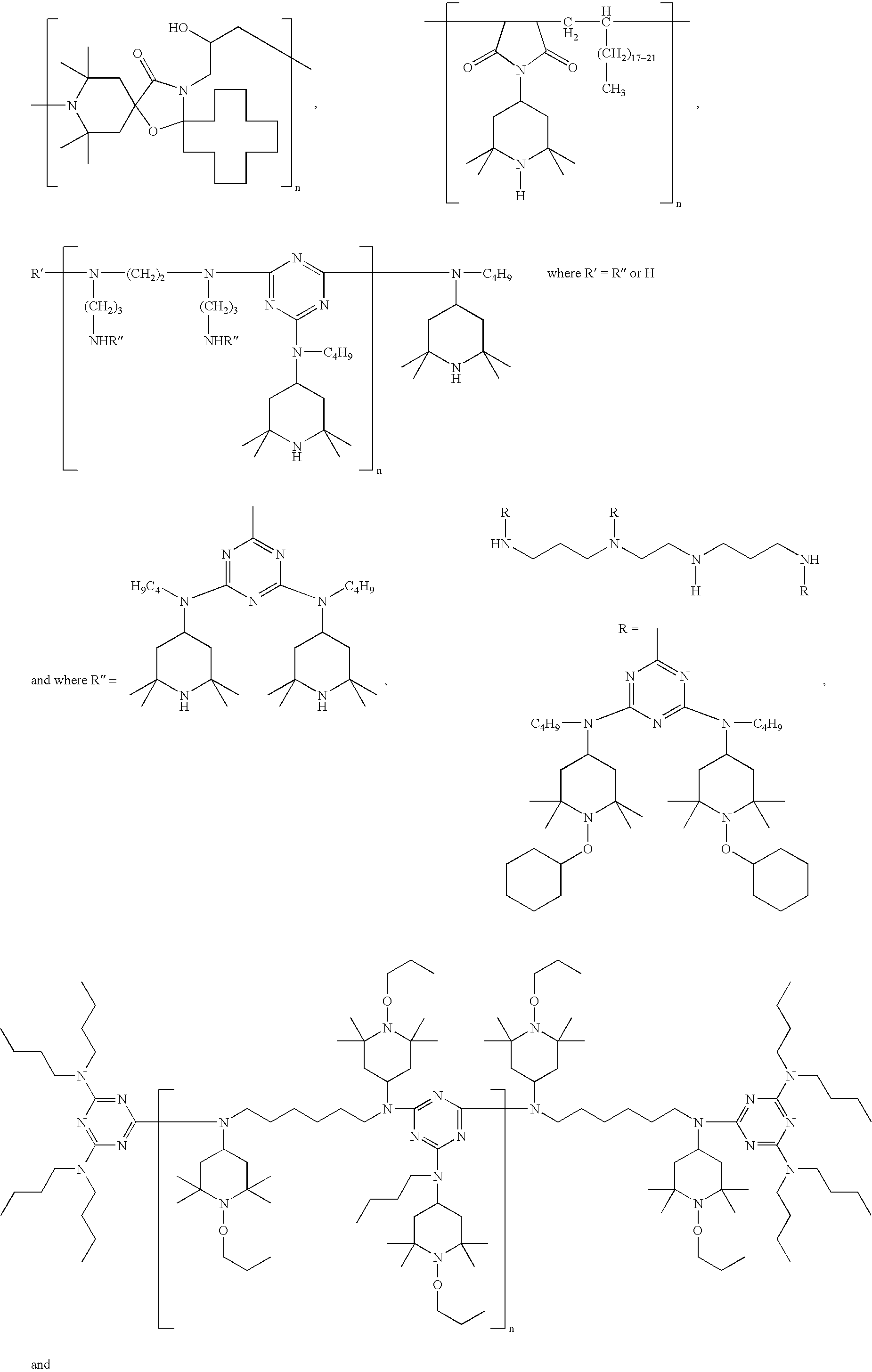 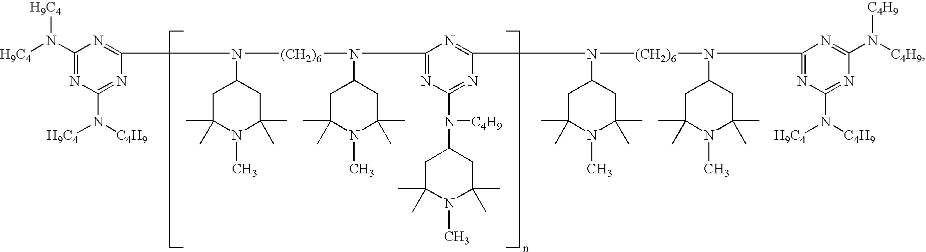
where n is an integer such that the total molecular weight of the oligomeric sterically hindered amine is above about 1000 g/mole.

Many of these compounds correspond to the written descriptions above, where the hindered amines are described as oligomeric or polycondensation products.

The UVAs and hindered amine stabilizers of this invention, in total, are present for example from about 0.05% to about 5% by weight, based on the weight of the polyolefin, for example from about 0.1% to about 1%, or in particular from about 0.2% to about 0.5% by weight, based on the weight of the polyolefin.

The weight:weight ratio of the UVAs to the hindered amines is from about 1:9 to about 9:1, for example from about 1:7 to about 7:1, from about 1:5 to about 5:1, or from about 1:3 to about 3:1.

The term “effective amount” in reference to the dyeability additives or in reference to the stabilization additives, is the that amount that results in the desired effect regarding dyeing and light stability, respectively.

As used herein, the terms “fiber” or “filament” refers to a flexible, synthetic, macroscopically homogeneous body having a high ratio of length to width and being small in cross section. These fibers may be produced by any of the processes known in the art, including but not limited to direct profile extrusion, and slit or fibrillated tapes. Hence, it is contemplated that the compositions of this invention are useful in the preparation of dyeable fibers including dyeable woven and non-woven polyolefin fibers.

The present compositions are prepared by melt extrusion processes to form fibers or filaments. In accordance with known technology such as continuous filament spinning for yarn or staple fiber, and nonwoven processes such as spunbond production and meltblown production, the fibers or filaments are formed by extrusion of the molten polymer through small orifices. In general, the fibers or filaments thus formed are then drawn or elongated to induce molecular orientation and affect crystallinity, resulting in a reduction in diameter and an improvement in physical properties. In nonwoven processes such as spunbonding and meltblowing, the fibers or filaments are directly deposited onto a foraminous surface, such as a moving flat conveyor and are at least partially consolidated by any of a variety of means including, but not limited to, thermal, mechanical or chemical methods of bonding. It is known to those skilled in the art to combine processes or the fabrics from different processes to produce composite fabrics which possess certain desirable characteristics. Examples of this are combining spunbond and meltblown to produce a laminate fabric that is best known as SMS, meant to represent two outer layers of spunbond fabric and an inner layer of meltblown fabric. Additionally either or both of these processes may be combined in any arrangement with a staple fiber carding process or bonded fabrics resulting from a nonwoven staple fiber carding process. In such described laminate fabrics, the layers are generally at least partially consolidated by one of the means listed above.

The invention is also applicable to melt extruded bi-component fibers, wherein one of the components is a polyolefin according to this invention.

Non-woven fabrics of polyolefin may have a carded fiber structure or comprise a mat in which the fibers or filaments are distributed in a random array. The fabric may be formed by any one of numerous known processes including hydroentanglement or spun-lace techniques, or by air laying or melt-blowing filaments, batt drawing, stitchbonding, etc., depending upon the end use of the article to be made from the fabric.

Spunbond filament sizes are from about 1.0 to about 3.2 denier. Melblown fibers typically have a fiber diameter of less than 15 microns and typically are less than 5 microns, ranging down to the submicron level. Webs in a composite construction may be processed in a wide variety of basis weights. The size of the fiber will depend on the end use. For instance, heavier fibers are often employed for carpet backing as opposed to fibers used to make clothing apparel and the like. The fibers of the present invention may be for example from about 1 to about 1500 denier.

Thermoplastic polypropylene fibers, which are typically extruded at temperatures in the range of from about 210° to about 240° C., are inherently hydrophobic in that they are essentially non-porous and consist of continuous molecular chains incapable of attracting or binding to dyes. As a result, untreated polypropylene fabrics, even while having an open pore structure, tend to resist the application of dyes.

According to the present invention, the dyeability additives and the light stabilizer additives are incorporated into a thermoplastic polyolefin, such as polypropylene, in the melt, and are extruded with the polyolefin into the form of fibers and filaments which are then quenched, attenuated and formed into fabrics, either in a subsequent or concomitant processing step.

The dyeability additives and the light stabilizer additives may be compounded with the polymer pellets which are to be melt extruded. To improve processing, the additives may be preformulated or compounded into a low MFR polypropylene which may also contain a small amount of inorganic powder, such as talc, and other traditional stabilizers.

The mixing of the additives into the polyolefin is done by mixing it into molten polymer by commonly used techniques such as roll-milling, mixing in a Banbury type mixer, or mixing in an extruder barrel and the like. The heat history (time at which held at elevated temperature) can be shortened by mixing the additives with unheated polymer particles so as to achieve substantially even distribution of the agent in the mass of polymer, thereby reducing the amount of time needed for intensive mixing at molten temperature.

Conveniently, the additives can also be added substantially simultaneously or sequentially with any other additives which may be desired in certain instances. The additives may also be preblended with other additives and the blend then added to the polymer. It is contemplated that in some instances the additives may have the additional benefit of aiding the other additives to become more easily or evenly dispersed or dissolved in the polyolefin. For easier batch-to-batch control of quality, it may be preferred to employ concentrated masterbatches of polymer/additive blends which are subsequently blended, as portions, to additional quantities of polymer to achieve the final desired formulation. The masterbatch, or the neat additives, may be injected into freshly prepared polymer while the polymer is still molten and after it leaves the polymerization vessel or train, and blended therewith before the molten polymer is chilled to a solid or taken to further processing.

The incorporation of the dyeability additives into a polyolefin fiber or filament according to the present invention results in observed improved dyeability of these naturally hydrophobic materials. This modification is also durable, such that the fibers or filaments and fabrics made therefrom do not lose their dyeability upon aging or handling. The improved dyeability is stable to repeated washings without a loss of performance, even over extended time periods.

The present invention is aimed at nonwoven fabrics, for example polypropylene fabrics. It is also aimed at threads or yarns for weaving or knitting in conventional textile processes.

The compositions of this invention are useful in staple fibers, continuous filament yarns, texturized filament yarns, ribbon material, fibrillated ribbons, films, nonwovens, woven and knitted fabrics, needled felt, woven and tufted carpets, woven garments, furniture and automobile upholstery, woven industrial fabrics, non-woven absorbents used in disposable diapers, non-woven garments including disposable medical garments, filter media, synthetic paper and the like.

The additives of the present invention are effective irrespective of other factors that influence the properties of nonwoven fabrics, for example, basis weight, fiber diameter, degree and type of bonding of the fibers, and the synergistic effects and influence of composite structures, such as the already describes SMS structures.

The present invention is not limited to single-component fibers. Polyolefin bi-component fibers, particularly side-by-side or sheath-core fibers of polypropylene and polyethylene would be expected to demonstrate the same practical benefits as single component fibers of either type.

The dyeable fabrics prepared from the fibers and filaments of the present invention include woven garments (outerwear and underwear); carpeting; furniture and automobile upholstery, woven industrial fabrics; non-woven absorbents used in diapers, sanitary pads, incontinence pads, wet and dry wipes, wound dressings, spill abatement, and medical absorbent pads; non-woven garments, including disposable medical garments; felts; pressed sheets; geo-textiles; filters (bipolar); packaging materials, including envelopes, and synthetic paper.

The fabrics of the present invention may be sterilized by exposure to about 0.5 to about 10 megarads of gamma irradiation. Sterilization with gamma irradiation is employed for hospital garments and the like.

The present polyolefin fibers, filaments and fabrics may also have incorporated or applied thereto appropriate other additives such as antioxidants, processing aids and other additives.

For example, the compositions of the invention may optionally also contain from about 0.01 to about 10%, preferably from about 0.025 to about 5%, and especially from about 0.1 to about 3% by weight of various conventional stabilizer coadditives, such as the materials listed below, or mixtures thereof.

Antioxidants

1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-methoxy-methylphenol, nonylphenols which are linear or branched in the side chains, for example, 2,6-di-nonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl)adipate.

4. Tocopherols, for example α-tocopherol, β-tocopherol, γ-tocopherol, δ-tocopherol and mixtures thereof (Vitamin E).

5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

7. Benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl)sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl)isocyanurate, 1,3,5-tris-(4-tert-butyl-3-hydroxy-2,6-dimethylbenzyl)isocyanurate, 3,5-di-tert-butyl-4-hydroxybenzyl-phosphoric acid dioctadecyl ester and 3,5-di-tert-butyl-4-hydroxybenzyl-phosphoric acid monoethyl ester, calcium-salt.

8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxy-benzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.

11. Benzylhosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

12. Acylaminophenols, for example 4-hydroxy-lauric acid anilide, 4-hydroxy-stearic acid anilide, 2,4-bis-octylmercapto-6-(3,5-tert-butyl4-hydroxyanilino)-s-triazine and octyl-N-(3,5-di-tert-butyl-4-hydroxyphenyl)-carbamate.

13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexane-diol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethyl-olpropane, 4-hydroxymethyl-1-phospha-2,6,7-trioxabicyclo[2.2.2]octane.

15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

16. Esters of 3,5-di-tert-butyl4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)-hydrazide, N,N′-bis[2-(3-[3,5-di-tert-butyl-4-hydroxyphenyl]propionyloxy)ethyl]oxamide (Naugard®XL-1 supplied by Uniroyal).

18. Ascorbic acid (vitamin C)

19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyl-diphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazin, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

Phosphites and phosphonites, for example triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)4,4′-biphenylene diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite.

Especially preferred are the following phosphites:

Tris(2,4-di-tert-butylphenyl)phosphite (Irgafos®168, Ciba Specialty Chemicals Corp.), tris(nonylphenyl)phosphite,

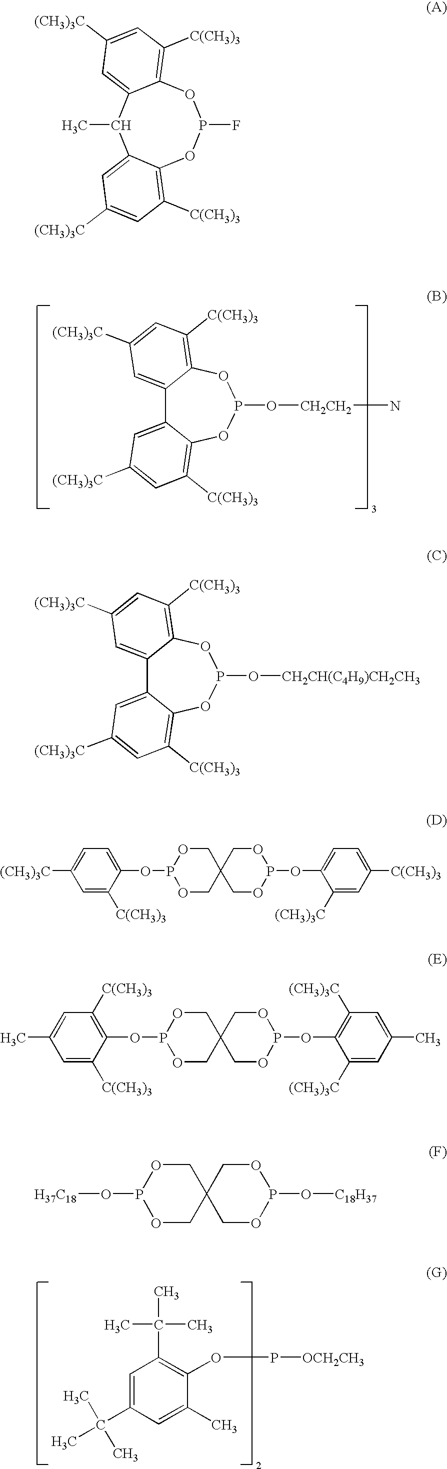

Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxyl-amine, N-heptadecyl-N-octadecylhydroxylamine, N-methyl-N-octadecylhydroxylamine and the N,N-dialkylhydroxylamine derived from hydrogenated tallow amine.

Nitrones, for example N-benzyl-α-phenylnitrone, N-ethyl-α-methylnitrone, N-octyl-α-heptylnitrone, N-lauryl-α-undecyinitrone, N-tetradecyl-α-tridcylnitrone, N-hexadecyl-α-pentadecylnitrone, N-octadecyl-α-heptadecyinitrone, N-hexadecyl-α-heptadecylnitrone, N-octadecyl-α-pentadecylnitrone, N-heptadecyl-α-heptadecylnitrone, N-octadecyl-α-hexadecylnitrone, N-methyl-α-heptadecylnitrone and the nitrone derived from N,N-dialkylhydro-xylamine derived from hydrogenated tallow amine.

Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.

Benzofuranones and indolinones, for example those disclosed in U.S. Pat. Nos. 4,325,863, 4,338,244, 5,175,312, 5,216,052, 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butyl-benzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, Irganox® HP-136, Ciba Specialty Chemicals Corp., and 3-(2,3-dimethylphenyl)-5,7-di-tert-butyl-benzofuran-2-one.

Thiosynergists, for example dilauryl thiodipropionate or distearyl thiodipropionate.

Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

Polyamide stabilizers, for example copper salts in combination with iodides and/or phosphorus compounds and salts of divalent manganese.

Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

Nucleating agents, for example inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

Dispersing Agents, such as polyethylene oxide waxes or mineral oil.

16. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS# 18600-59-4), and blowing agents.

For example, additives commonly used in this art may be optionally incorporated into the dyeable fibers of the present invention. Representative examples of such materials include hydrophilic modifiers such as monoglyceride such as glycerol monostearate, long chain hydrocarbon with hydrophilic groups appended such as a potassium or sodium salt of a linear alkyl phosphate, or combination thereof. The hydrophilic groups may be carboxylates, sulfates, sulfonates, phosphates, phosphonates, as well as quaternary ammonium salts and polyether groups. In addition, swelling agents can be used during dyeing as well as wetting agents, dye compatibilizers and thickening agents such as various gums. Since polyolefin fibers are often used in outdoor applications, such as outdoor carpeting, the addition of UV stabilizers may be advantageously added. Also, antioxidants may be added to the compositions.

In addition, it is contemplated that the present compositions will exhibit improved washability of a polyolefin-based textile fabric or non-woven mat. The nonpolar polyolefin tends to hold onto dirt due to the hydrophobic nature of both. The present dyeability additives are expected to facilitate detergents to penetrate the fabric or matrix so the detergents can loosen and wash away the dirt and oils.

It is also contemplated that the incorporation of the present dyeability additives in a polyolefin will increase the absorption and wickability of polyolefin textiles and non-wovens. One example is the melt blown, non-woven absorbent in baby diapers. Making the surface of the non-woven filament more hydrophilic by incorporating the polar dyeability additives into the polyolefin is expected to greatly increase the diaper's moisture absorption characteristics.

It is also contemplated that the incorporation of the dyeability additives will increase the abrasion resistance of fibers, fabrics, and other articles. Abrasion resistance is important in the drawing of formed fibers. Typically, a sizing is applied to reduce friction between the fiber and the metal surfaces of the drawing system.

Polyolefin woven and nonwoven fibers and fabrics prepared according to the present invention also exhibit exceptional printability. As a result of their inherent hydrophobic nature, polyolefin fibers and fabrics may exhibit problems towards printability, that is standard printing techniques. The compositions of the present invention overcome these problems as well.

Conventional methods can be employed to dye the fibers of this invention. For instance, the fibers may be dyed in a dye bath using conventional dyes and disperse dye techniques. Generally, the dye is applied in the form of a dye solution so that it can be readily applied by dipping the fiber through a trough, for example, containing the dye solution, or by spraying the dye solution on the fiber, or by using a cascading roll technique. As is common, the dye solution can be in the form of a print paste, from which the dyeing is typically conducted by roller printing or screen printing. The fibers can be dyed multiple times using one or more dyeing techniques.

Aqueous dye baths typically have a pH of from about 2 to about 11, generally between about 2 to about 6 for acid dyes. The pH may be adjusted if desired using a variety of compounds, such as formic acid, acetic acid, sulfamic acid, citric acid, phosphoric acid, nitric acid, sulfuric acid, monosodium phosphate, tetrasodium phosphate, trisodium phosphate, ammonium hydroxide, sodium hydroxide, and combinations thereof. Use of a surfactant can be used to aid in dispersing sparingly water soluble disperse dyes in the dye baths. Typically, nonionic surfactants can be employed for this purpose. During the dying step, the dye bath may be agitated to hasten the dyeing ratio. The dyeing step can be carried out at a variety of temperatures, with higher temperatures generally promoting the rate of dyeing.

Another technique known in the art is jet dyeing, which permits high-temperature dyeing and impingement of the dye onto the moving fabric through use of a venturi jet system. Carriers permit faster dyeing at atmospheric pressure and below 100° C. The carriers are typically organic compounds that can be emulsified in water and that have affinity for the fiber. Representative examples of such carriers include aromatic hydrocarbons such as diphenyl and methylnaphthalene, phenols such as phenylphenol, chlorinated hydrocarbons such as dichloro- and tricolor-benzene, and aromatic esters such as methyl salicylate, butyl benzoate, diethylphthalate, and benzaldehyde. Carriers are generally removed after dyeing.

Subsequent to dyeing, using a dye mixture with additives above, dry heat may be applied to the fibers at a wide range of elevated temperatures to cause the dye to penetrate into, and become fixed in, the fiber. The dye fixation step involves exposing the fiber to dry heat, such as in an oven. The temperature can vary up to the melt or glass transition temperature of the composition fiber. Generally, higher drying temperatures result in shorter drying times. Typically, the heating time is from about 1 minute to about 10 minutes. Residual dye may then be removed from the fibers.

A disperse dye mixture may thus be applied to the polypropylene fibers in various ways. The dye mixture may be applied intermittently along the length of yarn formed from fibers using various well known techniques to create a desired effect. One suitable method of dyeing fibers may be referred to as the “knit-deknit” dyeing technique. According to this method, the fibers are formed into a yarn which in turn is knit, typically into a tubing configuration. The dye mixture is then intermittently applied to the knit tubing. After dyeing, the tubing is unraveled and the yarn thus has an intermittent pattern. According to an alternative printing method, the fibers are first formed into yarn which is then woven or knitted into fabric, or is tufted into the carpet. A conventional flat screen printing machine may be used for applying the dye mixture to the fabric or carpet.

Continuous dyeing is carried out on a dyeing range where fabric or carpet is continuously passed through a dye solution of sufficient length to achieve initial dye penetration. Some disperse dyes may be sublimated under heat and partial vacuum into polymer fiber by methods known in the art. Printing of polyolefin compositions made in accordance with this invention can be accomplished with disperse dyes by heat transfer printing under pressure with sufficient heating to cause diffusion or disperse dyes into the polyolefin. Block, flat screen, and heat transfer batch processes, and engraved roller and rotary screen printing continuous processes may be used. Different dye solutions may be jet-sprayed in programmed sequence onto fabric or carpet made of the compositions of this invention as the fabric passes under the jets to form patterns. Dye solution may be metered and broken or cut into a pattern of drops that are allowed to drop on a dyed carpet passing underneath to give a diffuse over-dyed pattern on the carpet. Competitive dyeing of polyolefins is useful when dyeing styled carpets consisting of several different fibers such as nylon, polyester, etc., and a polyolefin. Different styling effects can be produced by controlling shade depth on each type of fiber present. Acid, disperse and premetallized dyes, or combinations thereof, depending upon the fibers present, can be employed to obtain styling effects. It may be possible to produce tweed effects by controlling the amount of reaction product and/or dyeability additives in the dyeable composition. Print dyeing, space dyeing, and continuous dyeing can be carried out with fabrics made from such yarns.

There are many commercially available disperse dyes. Dyes are classified based on method of application and, to a lesser extent, on chemical constitution by the Society of Dyers and Colorists. Various disperse dyes may be found in the listing “Dyes and Pigments by Color Index and Generic Names” set forth in Textile Chemist and Colorist, July 1992, Vol. 24, No. 7, a publication of the American Association of Textile Chemists and Colorists.

Dyes are intensely colored substances used for the coloration of various substrates, such as paper, plastics, or textile materials. It is believed that dyes are retained in these substrates by physical absorption, by salt or metal-complex formation, or by the formation of covalent chemical bonds. The methods used for the application of dyes to the substrate differ widely, depending upon the substrate and class of dye. It is by applications methods, rather than by chemical constitutions, that dyes are differentiated from pigments. During the application process, dyes lose their crystal structures by dissolution or vaporization. The crystal structures may in some cases be regained during a later stage of the dyeing process. Pigments, on the other hand, retain their crystal or particulate form throughout the entire application procedure.

A large number of dyes, with widely differing properties, are therefore necessary because of the great variety of materials to be dyed. On a worldwide basis, it is believed that several thousand different dyes have achieved commercial significance. Generally, dyes have been classified into groups two ways. One method of classification is by chemical constitution in which the dyes are grouped according to the chromophore or color giving unit of the molecule. A second method of classification is based on the application class of end-use of the dye. The dual classification system used in the color index (CI) is accepted internationally throughout the dye-manufacturing and dye-using industries. In this system, dyes are grouped according to chemical class with a CI number for each chemical compound and according to usage or application class with a CI name for each dye. Disperse dyes are generally water-insoluble nonionic dyes typically used for dyeing hydrophilic fibers from aqueous dispersion. Disperse dyes have been used on polyester, nylon, and acetate fibers.

Preferably, the dyes according to this invention are anthraquinone blue dyes, anthraquinone red dyes, diazo red dyes or nitro yellow dyes. For example, the present dyes are anthraquinone blue dyes, anthraquinone red dyes or nitro yellow dyes.

For example, the present dyes are anthraquinone dyes.

For instance, the present dyes are Blue BLF (CI 60766, CI Disperse Blue 120, CI Disperse Blue 77), Blue GLF (CI 60767, CI Disperse Blue 27), Blue BGE-01-200 (CI 61104, CI 668210, CI Disperse Blue 60, CI Disperse Blue 99), Blue R200 (CI 63265), Blue 3RL-02 (CI 63285), Red FBN (CI Disperse Red 60), Red CB (CI 26765), Yellow GWL (CI 10338, CI Disperse Yellow 37, CI Disperse Yellow 42), Yellow CR (CI 40001, CI Direct Yellow 6) or Yellow HLG (CI 58840).

A number of spin finishes can be applied to the fibers prior to drawing. Such finishes can be water-based. The spin finishes can be anionic or nonionic, as is well known in the art. Also, the fibers can be finished prior to dyeing, as by texturizing through mechanical crimping or forming, as is well known in the art.

It is contemplated that the stabilizer systems according to the present invention may be effective for other known polyolefin dyeability additives. For example, the dyeability additive mixtures of the present invention may be substituted with polyetheresteramides according to U.S. Pat. No. 6,679,754, incorporated by reference, with polyesters, with polyetheramines, with polypropylene grafted with maleic anhydride, with hyperbranched or dendrimer versions of these polymers, and with polypropylene with polar side chains.

The following examples illustrate the invention in more detail. They are not to be construed as limiting the invention in any manner whatsoever. All parts and percentages are by weight unless otherwise indicated.

Additives used in the present Examples are:

UVAs:
HPT: 2,4-diphenyl-6-(2-hydroxy-4-hexyloxyphenyl)-s-triazine
BZT: 5-chloro-2-(2-hydroxy-3,5-di-tert-butylphenyl)-2H-benzotriazole

HALS:
NH: oligomeric compound which is the polycondensation product of 2,4-dichloro-6-tert-octylamino-s-triazine and 4,4′-hexamethylenebis(amino-2,2,6,6-tetramethylpiperidine)
NMe: N,N′,N″,N′″-tetrakis[(4,6-bis(butyl-1,2,2,6,6-pentamethylpiperidin-4-yl)-amino-s-triazin-2-yl]-1,10-diamino-4,7-diazadecane
NORP: oligomeric compound which is the condensation product of 4,4′-hexamethylene-bis(amino-(1-propyloxy-2,2,6,6-tetramethylpiperidine)) and 2,4-dichloro-6-[(1-propyloxy-2,2,6,6-tetramethylpiperidin-4-yl)butylamino]-s-triazine end-capped with 2-chloro-4,6-bis(dibutylamino)-s-triazine

Dyeability Additives

A mixture of copolyamide and ethylene vinyl acetate

### EXAMPLE 1

### Polypropylene Fiber Dyeability and Light Stability

Polypropylene Fiber Preparation

Fiber grade polypropylene, Montell PROFAX 6301, stabilizer additives and dyeability additives are weighed based on a batch of 1,000 gram total. The ingredients are placed in a plastic bag and tumble mixed. The mix is fed into a HILLS LAB FIBER EXTRUDER with a 41 hole round spinneret. The temperature profile of the extruder is at 400, 425, 450, 475, and 475° F. A constant pressure of 750 psi controls the screw speed via a feed back loop. The feed, draw, and relax rolls are at 175, 212 and 212° F., and are rotating at 120, 600 and 575 meters per minute. The draw ratio is 5:1 (600 Meters/min/120 meters/min). The fiber comes in contact with a 6% aqueous fiber finish solution just before the feed roll. The fiber finish solution is LUROL PP-4521 from Goulston Industries. A LEESONA winder at the end of the line collects the fiber onto a spool. The final denier per filament is 10. The total denier for the yarn is 410 (41 filaments×10 denier). The collected fiber is removed from the spool and is knitted into a sock with a LAWSON HEMPHILL FAK sampler knitter. Ten gram samples are cut from the sock.

Dyeing Process

Dye Solution Preparation

Solutions of disperse dyes are prepared by dissolving 1.000 g of the dye into 1,000 g of distilled water. These solutions will serve as the dye master solutions. For disperse dyes, the water is heated to 145-185° F. and then the dye is added to the water.

Dye Auxiliary Solution Preparation

A dye auxiliary solution is made containing: buffer (ammonium sulfate 1.25 g/L), leveler (Ciba Tinegal® ALS 0.625 g/L), lubricant (Cibafluid® LA 1.875 g/L), and defoamer (Cibaflow® SF 0.125 g/L). Acetic acid at a concentration of 10% (w/w) is used to adjust the pH to 4.5-5.5. This is the master dye auxiliary solution.

Polypropylene Fiber Dyeing

A ROACHES programmable dye bath is set to the following conditions: temperature rise of 2° C. per minute from 30° C. to 125° C. with a hold time of 60 minutes at 125° C. then a cool down at maximum cooling of 5.5° C. per minute. To obtain a 0.4% dye On the Weight of Fiber (OWF), 40 grams of the dye master solution, 160 g of the auxiliary master solution, 10 g polypropylene sock prepared as described previously, are all added to the ROACHES steel 250 cc cylinder. The liquor ratio therefore is 20-1. The cylinder is sealed, placed into the dye bath, and the cycle & cylinder rotation is started. After the dye cycle is completed, the sock is removed from the cylinder. The sock is then rinsed with tap water. The excess water is removed from the sock via a centrifuge extractor and is dried in a forced air oven at 100° C. for 15 minutes.

Reduction Clearance

The socks are then reduction-cleared to remove loose dye not fixed to the fiber. This is done by treating the 10 g dyed polypropylene sock for 10 minutes at 30° C. with 200 cc of the following solution: 3 cc/L 40% NaOH w/v, 1 g/L sodium hydrosulfite. After the reduction clearance, the sock is rinsed and dried as described previously.

Equipment and Procedure Used for Evaluation of Lightfastness

Details for Measuring Color Change, K/S, Crockfastness, and Washfastness

The finished dyed socks are folded twice and the K/S value is measured at the wavelength of minimum reflectance on a Datacolor Spectrophotometer SF600. Instrument conditions are: CIE lab, D65 illuminant, 10 degree observer, spectral component included (SCI), small area view (SAV), scanning wavelength=400-700 nm. A higher K/S value indicates greater depth of shade. K/S values are calculated by the instrument where K=absorption, S=scattering, R=the reflectance value at the minimum reflectance:
K/S=(1−R)²/2R

The samples are weathered according to ASTM G26 in an Atlas Ci65A xenon arc WeatherOmeter. The WeatherOmeter (dry) conditions are: black panel temperature=63° C., irradiance=0.35 W/m², wet bulb depression=14° C., conditioning water=38° C., cycle=continuous light, filters=borosilicate.

Color change, before vs after weathering, is the delta E (DE) value. DE is calculated by the instrument from the L, a, and b values, from the CIE system, from the reflectance values, using the equation given below:
[(Delta L)²+(Delta a)²+(Delta b)²]^{1/2}=Delta E (DE)

The following samples are prepared. All Samples contain 8 weight % of the dyeability additive mixture.

Control Blue A
Dye: 0.4 OWF Blue R200
no stabilizers

Control Red A
Dye: 0.4 OWF Red FBN
no stabilizers

Control Yellow A
Dye: 0.4 WOF Yellow CR
no stabilizers

Control Blue B
Dye: 1.0 OWF Blue R200
no stabilizers

Control Red B
Dye: 1.0 OWF Red FBN
no stabilizers

Control Yellow B
Dye: 1.0 OWF Yellow CR
no stabilizers

A) Dye: 0.4 OWF Blue R200
StabilizerAdditves: 0.12% HPT, 0.17% NORP

B) Dye: 0.4 OWF Blue R200
Stabilizer Additives: 0.12% HPT, 0.18% NH, 0.12% BZT

C) Dye: 0.4 OWF Red FBN
Stabilizer Additives: 0.12% HPT, 0.17% NORP

D) Dye: 0.4 OWF Red FBN
Stabilizer Additives: 0.12% HPT, 0.18% NH, 0.12% BZT

E) Dye: 0.4 OWF Yellow CR
Stabilizer Additives: 0.12% HPT, 0.17% NORP

F) Dye: 0.4 OWF Yellow CR
Stabilizer Additives: 0.12% HPT, 0.17% NMe

G) Dye: 1.0 OWF Blue R200
Stabilizer Additives: 0.12% HPT, 0.17% NORP

H) Dye: 1.0 OWF Blue R200
Stabilizer Additives: 0.12% HPT, 0.17% NMe

J) Dye: 1.0 OWF Red FBN
Stabilizer Additives: 0.12% HPT, 0.17% NORP

K) Dye: 1.0 OWF Red FBN
Stabilizer Additives: 0.12% HPT, 0.12% BZT

L) Dye: 1.0 OWF Yellow CR
Stabilizer Additives: 0.12% HPT, 0.17% NORP

M) Dye: 1.0 OWF Yellow CR
Stabilizer Additives: 0.12% HPT, 0.17% NMe

Results are in the following table. The K/S of the blue dyed samples is measured at 630 nm, the red dyed samples at 520 nm, and the yellow dyed samples at 450 nm.

| Sample | K/S | DE@ 240 hours |
|---|---|---|
| Control Blue A | 10.1 | 35.0 |
| A | 10.9 | 11.5 |
| B | 11.6 | 13.2 |
| Control Red A | 10.8 | 38.6 |
| C | 10.1 | 8.7 |
| D | 10.7 | 7.4 |
| Control Yellow A | 14.7 | 24.6 |
| E | 15.0 | 15.1 |
| F | 14.5 | 17.0 |
| Control Blue B | 15.4 | 25.5 |
| G | 15.5 | 9.9 |
| H | 17.5 | 9.1 |
| Control Red B | 17.8 | 21.9 |
| J | 19.2 | 13.1 |
| K | 19.5 | 15.0 |
| Control Yellow B | 15.5 | 31.1 |
| L | 18.4 | 17.8 |
| M | 16.5 | 16.9 |

The present inventive formulations exhibit excellent dyeability and lightfastness.

The lightfastness for example is measured as having a DE at 240 hours of less than about 20 as measured according to ASTM G26, for instance the present DE is less than about 15 at 240 hours as measured according to ASTM G26.

1. A dyed, light stable polyolefin fiber or filament,
which comprises a melt blend which comprises
i) a polyolefin substrate,
ii) an effective amount of a combination of
at least one dyeability additive compound selected from the group consisting of the polyamides, copolyamides and polyetherpolyamides and
at least one dyeability additive compound selected from the group consisting of the ethylene vinyl acetate copolymers and
iii) an effective amount of a combination of
at least one additive compound selected from the group consisting of the ultraviolet light absorbers and
at least one additive compound selected from the group consisting of the hindered amine light stabilizers
and which fiber or filament further comprises at least one disperse dye.

2. A fiber or filament according to claim 1 in which the polyolefin is polypropylene or polyethylene.

3. A bi-component fiber comprising a component comprising a melt blend according to claim 1.

4. A woven or nonwoven fabric comprising polyolefin fibers or filaments according to claim 1.

5. A woven or nonwoven fabric comprising polyethylene or polypropylene fibers or filaments according to claim 1.

6. A woven or nonwoven fabric comprising bi-component fibers comprising a component comprising a melt blend according to claim 1.

7. A fiber or filament according to claim 1 comprising at least one dyeability additive selected from the group consisting of the copolyamides.

8. A fiber or filament according to claim 7 wherein the copolyamides comprise the polycondensation products of at least two compounds selected from the group consisting of lactams of 6 to 12 carbon atoms and aminocarbonic acids of 6 to 12 carbon atoms, and equimolar quantities of a diamine of 4 to 12 carbon atoms and a diprimary carbonic acid of 6 to 36 carbon atoms.

9. A fiber or filament according to claim 7 wherein the copolyamides comprise the polycondensation products of about 20 to about 90% by weight, based on the copolyamide, of at least one lactam or linear aliphatic aminocarbonic acid of 6 to 12 carbon atoms and about 80 to about 10% by weight, based on the copolyamide, of equimolar quantities of a diamine of 4 to 12 carbon atoms and a diprimary carbonic acid of 6 to 36 carbon atoms.

10. A fiber or filament according to claim 7 wherein the copolyamides comprise the polycondensation products of from about 20 to about 90% by weight of at least two cyclolactams or at least two aminocarbonic acids, and from about 80 to about 10% by weight of equimolar quantities of a diamine and a dicarbonic acid, based on the weight of the copolyamide.

11. A fiber or filament according to claim 7 wherein the copolyamides are the polycondensation products of monomer mixtures PA6/PA6,6/PA12 with a weight:weight:weight composition of 40:20:40 or 40:40:20.

12. A fiber or filament according to claim 1 wherein the ethylene vinyl acetate copolymer contains from about 18 to about 33% vinyl acetate units by weight, based on the weight of the copolymer.

13. A fiber or filament according to claim 1 wherein the ethylene vinyl acetate copolymer contains from about 27 to about 29% vinyl acetate units by weight, based on the weight of the copolymer.

14. A fiber or filament according to claim 1 where the dyeability additives are present from about 7% to about 9% by weight, based on the weight of the polyolefin.

15. A fiber or filament according to claim 1 where the weight:weight ratio of the additives selected from the group consisting of the polyamides, copolyamides and polyetherpolyamides to the ethylene vinyl acetate copolymer is from about 1:3 to about 3:1.

16. A fiber or filament according to claim 1 wherein the ultraviolet light absorbers are selected from the group consisting of the hydroxyphenylbenzotriazoles and the tris-aryl-s-triazines.

17. A fiber or filament according to claim 1 wherein the ultraviolet light absorbers are selected from the group consisting of
4-octyloxy-2-hydroxybenzophenone,
4-methoxy-2-hydroxybenzophenone,
2-(2-hydroxy-5-methylphenyl)-2H-benzotriazole,
2-(2-hydroxy-5-tert-octylphenyl-2H-benzotriazole,
2-(2-hydroxy-3,5-di-tert-amylphenyl)-2H-benzotriazole,
octyl 3-(benzotriazol-2-yl)-5-tert-butyl-4-hydroxyhydrocinnamate,
2-(2-hydroxy-3,5-di-tert-butylphenyl)-2H-benzotriazole,
2-(2-hydroxy-5-tert-butylphenyl)-2H-benzotriazole,
5-chloro-2-(2-hydroxy-3,5-di-tert-butylphenyl)-2H-benzotriazole,
5-chloro-2-(2-hydroxy-3-tert-butyl-5-methylphenyl)-2H-benzotriazole,
2-(2-hydroxy-3-sec-butyl-5-tert-butylphenyl)-2H-benzotriazole,
2-(2-hydroxy-4-octyloxyphenyl)-2H-benzotriazole,
2-(2-hydroxy-3-dodecyl-5-methylphenyl)-2H-benzotriazole,
2-[2-hydroxy-3,5-di(α, α-dimethylbenzyl)phenyl]-2H-benzotriazole,
2-[2-hydroxy-3-(α,α-dimethylbenzyl)-5-tert-octylphenyl]-2H-benzotriazole,
2-{2-hydroxy-3-tert-butyl-5-[2-(omega-hydroxy-octa(ethyleneoxy)carbonyl)ethyl]phenyl}-2H-benzotriazole,
2-{2-hydroxy-3-tert-butyl-5-[2-(octyloxy)carbonyl)ethyl]phenyl}-2H-benzotriazole,
2-ethylhexyl p-methoxycinnamate,
4-methoxy-2,2′-dihydroxybenzophenone,
4,4′-dimethoxy-2,2′-dihydroxybenzophenone,
2,4-bis(2,4-dimethylphenyl)-6-(2-hydroxy-4-octyloxyphenyl)-s-triazine,
2,4-diphenyl-6-(2-hydroxy-4-hexyloxyphenyl)-s-triazine,
2,4-bis(2,4-dimethylphenyl)-6-[2-hydroxy-4-(3-do-/tri-decyloxy-2-hydroxypropoxy)phenyl]-s-triazine,
2,4-bis(2,4-dimethylphenyl)-6-[2-hydroxy-4-(3-do-/tri-decyloxy-2-hydroxypropoxy)-5-α-cumylphenyl]-s-triazine and
the reaction product of 2,4,6-tris(2,4-dihydroxyphenyl)-s-triazine with octyl α-haloacetate.

18. A fiber or filament according to claim 1 wherein the ultraviolet light absorbers are selected from the group consisting of
4-octyloxy-2-hydroxybenzophenone,
4-methoxy-2-hydroxybenzophenone,
2-(2-hydroxy-5-tert-octylphenyl-2H-benzotriazole,
2-[2-hydroxy-3-(α,α-dimethylbenzyl)-5-tert-octylphenyl]-2H-benzotriazole,
5-chloro-2-(2-hydroxy-3,5-di-tert-butylphenyl)-2H-benzotriazole,
2-{2-hydroxy-3-tert-butyl-5-[2-(omega-hydroxy-octa(ethyleneoxy)carbonyl)ethyl]phenyl}-2H-benzotriazole,
2-{2-hydroxy-3-tert-butyl-5-[2-(octyloxy)carbonyl)ethyl]phenyl}-2H-benzotriazole,
2,4-diphenyl-6-(2-hydroxy-4-hexyloxyphenyl)-s-triazine,
2,4-bis(2,4-dimethylphenyl)-6-[2-hydroxy-4-(3-do-/tri-decyloxy-2-hydroxypropoxy)phenyl]-s-triazine and
the reaction product of 2,4,6-tris(2,4-dihydroxyphenyl)-s-triazine with octyl α-haloacetate.

19. A fiber or filament according to claim 1 wherein the ultraviolet light absorbers are 5-chloro-2-(2-hydroxy-3,5-di-tert-butylphenyl)-2H-benzotriazole or 2,4-diphenyl-6-(2-hydroxy-4-hexyloxy-phenyl)-s-triazine.

20. A fiber or filament according to claim 1 wherein the hindered amine light stabilizers are selected from the group consisting of
bis(1-octyloxy-2,2,6,6-tetramethylpiperidin-4-yl)sebacate;
bis(1-cyclohexyloxy-2,2,6,6-tetramethylpiperidin-4-yl)sebacate;
1-cyclohexyloxy-2,2,6,6-tetramethyl-4-octadecylaminopiperidine;
2,4-bis[(1-cyclohexyloxy-2,2,6,6-tetramethylpiperidin-4-yl)butylamino]-6-(2-hydroxyethyl-amino-s-triazine;
bis(1-cyclohexyloxy-2,2,6,6-tetramethylpiperidin-4-yl)adipate;
the oligomeric compound which is the condensation product of 4,4′-hexamethylene-bis(amino-(1-octyloxy-2,2,6,6-tetramethylpiperidine) and 2,4-dichloro-6-[(1-octyloxy-2,2,6,6-tetramethylpiperidin-4-yl)butylamino]-s-triazine end-capped with 2-chloro-4,6-bis(dibutylamino)-s-triazine;
the oligomeric compound which is the condensation product of 4,4′-hexamethylene-bis(amino-(1-cyclohexyloxy-2,2,6,6-tetramethylpiperidine)) and 2,4-dichloro-6-[(1-cyclohexyloxy-2,2,6,6-tetramethylpiperidin-4-yl)butylamino]-s-triazine end-capped with 2-chloro-4,6-bis(dibutyl-amino)-s-triazine;
the oligomeric compound which is the condensation product of 4,4′-hexamethylene-bis(amino-(1-propyloxy-2,2,6,6-tetramethylpiperidine)) and 2,4-dichloro-6-[(1-propyloxy-2,2,6,6-tetramethylpiperidin-4-yl)butylamino]-s-triazine end-capped with 2-chloro-4,6-bis(dibutylamino)-s-triazine (the n-propoxy derivative of the corresponding N—H hindered amine below);
the oligomeric compound which is the condensation product of 4,4′-hexamethylene-bis(amino-(1-acetoyloxy-2,2,6,6-tetramethylpiperidine)) and 2,4-dichloro-6-[(1-acetoyloxy-2,2,6,6-tetramethylpiperidin-4-yl)butylamino]-s-triazine end-capped with 2-chloro-4,6-bis(dibutyl-amino)-s-triazine;
1-methoxy-4-hydroxy-2,2,6,6-tetramethylpiperidine;
1-octyloxy-4-hydroxy-2,2,6,6-tetramethylpiperidine;
1-cyclohexyloxy-4-hydroxy-2,2,6,6-tetramethylpiperidine;
1-methoxy-4-oxo-2,2,6,6-tetramethylpiperidine;
1-octyloxy-4-oxo-2,2,6,6-tetramethylpiperidine;
1-cyclohexyloxy-4-oxo-2,2,6,6-tetramethylpiperidine;
bis(1-heptyloxy-2,2,6,6-tetramethylpiperidin-4-yl)sebacate;
bis(1-nonyloxy-2,2,6,6-tetramethylpiperidin-4-yl)sebacate;
bis(1-dodecyloxy-2,2,6,6-tetramethylpiperidin4-yl)sebacate;
N,N′,N″,N′″-tetrakis[(4,6-bis(butyl-1-octyloxy-2,2,6,6-pentamethylpiperidin-4-yl)-amino-s-triazin-2-yl]-1,10-diamino-4,7-diazadecane; and

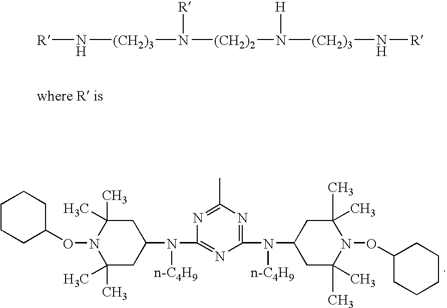

21. A fiber or filament according to claim 1 wherein the hindered amine light stabilizers are selected from the group consisting of
1-(2-hydroxy-2-methylpropoxy)-4-octadecanoyloxy-2,2,6,6-tetramethylpiperidine;
1-(2-hydroxy-2-methylpropoxy)-4-hydroxy-2,2,6,6-tetramethylpiperidine;
1-(2-hydroxy-2-methylpropoxy)-4-oxo-2,2,6,6-tetramethylpiperidine;
bis(1-(2-hydroxy-2-methylpropoxy)-2,2,6,6-tetramethylpiperidin4-yl)sebacate;
bis(1-(2-hydroxy-2-methylpropoxy)-2,2,6,6-tetramethylpiperidin-4-yl)adipate;
bis(1-(2-hydroxy-2-methylpropoxy)-2,2,6,6-tetramethylpiperidin-4-yl)succinate;
bis(1-(2-hydroxy-2-methylpropoxy)-2,2,6,6-tetramethylpiperidin-4-yl)glutarate; and
2,4-bis{N-[1-(2-hydroxy-2-methylpropoxy)-2,2,6,6-tetramethylpiperidin-4-yl]-N-butyl-amino}-6-(2-hydroxyethylamino)-s-triazine.

22. A fiber or filament according to claim 1 wherein the hindered amine light stabilizer is selected from the group consisting of
the oligomeric compound which is the condensation product of 4,4′-hexamethylene-bis(amino-(2,2,6,6-tetramethylpiperidine)) and 2,4-dichloro-6-[(2,2,6,6-tetramethylpiperidin-4-yl)butylamino]-s-triazine end-capped with 2-chloro-4,6-bis(dibutylamino)-s-triazine;
bis(2,2,6,6-tetramethylpiperidin-4-yl)sebacate;
polycondensation product of 2,4-dichloro-6-tert-octylamino-s-triazine and 4,4′-hexa-methylenebis(amino-2,2,6,6-tetramethylpiperidine);
polycondensation product of 1-(2-hydroxyethyl)-2,2,6,6-tetramethyl-4-hydroxypiperidine and succinic acid;
polycondensation product of 4,4′-hexamethylenebis-(amino-2,2,6,6-tetramethyl-piperidine) and 1,2-dibromoethane;
mixture of bis(2,2,6,6-tetramethylpiperidin-4-yl)sebacate and the polycondensation product of 2,4-dichloro-6-tert-octylamino-s-triazine and 4,4′-hexamethylenebis(amino-2,2,6,6-tetramethylpiperidine);
mixture of the polycondensation product of 1-(2-hydroxyethyl)-2,2,6,6-tetramethyl-4-hydroxypiperidine and succinic acid with the polycondensation product of 2,4-dichloro-6-tert-octylamino-s-triazine and 4,4′-hexamethylenebis(amino-2,2,6,6-tetramethylpiperidine);
bis(1,2,2,6,6-pentamethylpiperidin-4-yl)sebacate;
di(1,2,2,6,6-pentamethylpiperidin-4-yl) (3,5-di-tert-butyl-4-hydroxybenzyl)butylmalonate;
4-benzoyl-2,2,6,6-tetramethylpiperidine;
4-stearyloxy-2,2,6,6-tetramethylpiperidine;
tris(2,2,6,6-tetramethylpiperidin4-yl)nitrilotriacetate;
tetrakis(2,2,6,6-tetramethylpiperidin-4-yl)1,2,3,4-butanetetracarboxylate;
tetrakis(1,2,2,6,6-pentamethylpiperidin-4-yl)1,2,3,4-butanetetracarboxylate;
polycondensation product of 2,4-dichloro-6-morpholino-s-triazine and 4,4′-hexa-methylenebis(amino-2,2,6,6-tetramethylpiperidine);
polycondensation product of 2,4-dichloro-6-morpholino-s-triazine and 4,4′-hexa-methylenebis(amino-(1-methyl-2,2,6,6-tetramethylpiperidine));
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane;
octamethylene bis(2,2,6,6-tetramethylpiperidin-4-carboxylate);
N-2,2,6,6-tetramethylpiperidin-4-yl-n-dodecylsuccinimide;
N-1,2,2,6,6-pentamethylpiperidin-4-yl-n-dodecylsuccinimide;
N-1-acetyl-2,2,6,6-tetramethylpiperidin-4-yln-dodecylsuccinimide;
4-C₁₅-C₁₇alkanoyloxy-2,2,6,6-tetramethylpiperidine;
polycondensation product of 2,4-dichloro-6-cyclohexylamino-s-triazine and 4,4′-hexa-methylenebis(amino-2,2,6,6-tetramethylpiperidine);
1,5-bis(2,2,6,6-tetramethylpiperidin-4-yl)-1,5-diaza-4-oxopropane;
copolymer of methyl methracrylate, ethyl acrylate and 2,2,6,6-tetramethylpiperidin-4-yl acrylate;
copolymer of N-octadecylmaleimide, styrene and N-(2,2,6,6-tetramethylpiperidin-4yl)maleimide;
1,3,5-tris[3-(2,2,6,6-piperidin-4-ylamino)-2-hydroxy-propyl)isocyanurate;
olefin copolymer containing units derived from N-[2-(2,2,6,6-tetramethylpiperidin-4-yl)-oxalamid-1-yl]maleimide;
2,2,4,4-tetramethyl-7-oxa-3,20-diaza-21-oxo-dispiro[5,1,11,2]heneicosane;
C₁₂-C₁₄alkyl 3-(2,2,4,4-tetramethyl-7-oxa-3,20-diaza-21-oxo-dispiro[5,1,11,2]heneicosane-20-yl)propionate;
reaction product of epichlorohydrin and 2,2,4,4-tetramethyl-7-oxa-3,20-diaza-21-oxo-dispiro[5,1,11,2]heneicosane;
1,3-di(2,2,6,6-tetramethylpiperidin-4-yl)2,4-ditridecyl butanetetracarboxylate;
1,3-di(1,2,2,6,6-pentamethylpiperidin-4-yl)2,4-ditridecyl butanetetracarboxylate;
polycondensation product of 3,9-bis(1,1-dimethyl-2-hydroxyethyl)-2,4,8,10-tetraoxaspiro-[5.5]undecane, tetramethyl 1,2,3,4-butanetetra-carboxylate and 2,2,6,6-tetramethyl-4-hydroxy-piperidine;
polycondensation product of 3,9-bis(1,1-dimethyl-2-hydroxyethyl)-2,4,8,10-tetraoxaspiro-[5.5]undecane, tetramethyl 1,2,3,4-butanetetra-carboxylate and 1,2,2,6,6-pentamethyl-4-hydroxypiperidine;
1,4-bis(2,2,6,6-tetramethylpiperidin-4-yl)-2,2-dimethyl-1,4-diaza-4-oxopropane;
reaction product of 4-amino-2,2,6,6-tetramethylpiperidine and tetramethylolacetylene-diurea;
1,6-hexamethylenebis[N-formyl-N-(2,2,6,6-tetramethylpiperidin-4-yl)amine];
copolymer of N-(2,2,6,6-tetramethylpiperdin-4-yl)maleimide and a C₂₀-C₂₄-alpha-olefin;
poly[3-(2,2,6,6-tetramethylpiperidin-4-yloxy)propyl-methyl-siloxane];
polycondensation product of 2,4-dichloro-6-[N-butyl-N-(2,2,6,6-tetramethylpiperidin-4-yl)amino]-s-triazine and 1,10-diamino-4,7-diazadecane;
dodecyl 3-(2,2,4,4-tetramethyl-7-oxa-3,20-diaza-21-oxo-dispiro[5,1,11,2]heneicosane-20-yl)propionate;

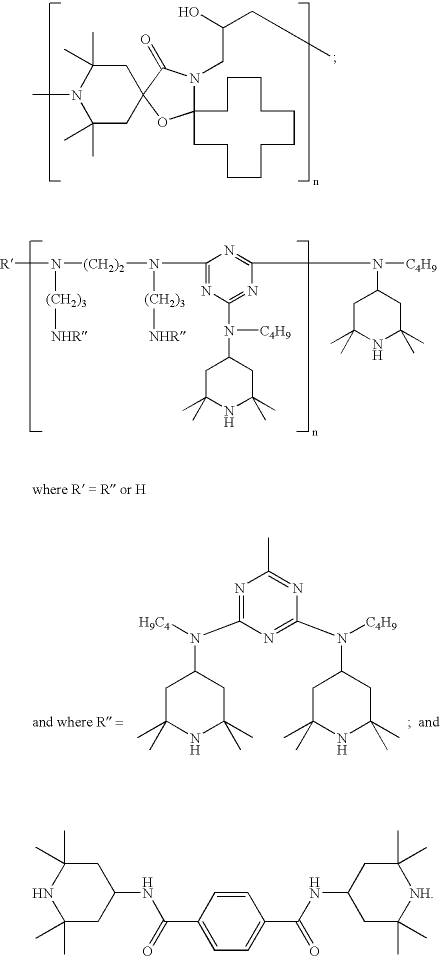

23. A fiber or filament according to claim 1 wherein the hindered amine light stabilizer is selected from the group consisting of
the oligomeric compound which is the condensation product of 4,4′-hexamethylene-bis(amino-(1-propyloxy-2,2,6,6-tetramethylpiperidine)) and 2,4-dichloro-6-[(1-propyloxy-2,2,6,6-tetramethylpiperidin-4-yl)butylamino]-s-triazine end-capped with 2-chloro-4,6-bis(dibutylamino)-s-triazine (CAS# 247243-62-5); 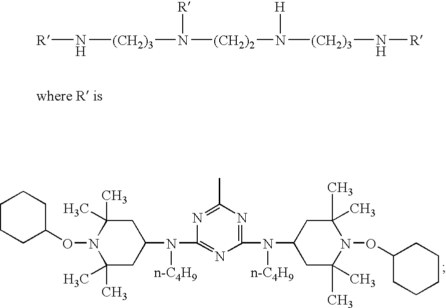
the oligomeric compound which is the condensation product of 4,4′-hexamethylene-bis(amino-(2,2,6,6-tetramethylpiperidine)) and 2,4-dichloro-6-[(2,2,6,6-tetramethylpiperidin-4-yl)butylamino]-s-triazine end-capped with 2-chloro-4,6-bis(dibutylamino)-s-triazine;
bis(2,2,6,6-tetramethylpiperidin-4-yl)sebacate;
polycondensation product of 2,4-dichloro-6-tert-octylamino-s-triazine and 4,4′-hexa-methylenebis(amino-2,2,6,6-tetramethylpiperidine);
polycondensation product of 1-(2-hydroxyethyl)-2,2,6,6-tetramethyl-4-hydroxypiperidine and succinic acid;
mixture of bis(2,2,6,6-tetramethylpiperidin-4-yl)sebacate and the polycondensation product of 2,4-dichloro-6-tert-octylamino-s-triazine and 4,4′-hexamethylenebis(amino-2,2,6,6-tetramethylpiperidine);
mixture of the polycondensatibn product of 1-(2-hydroxyethyl)-2,2,6,6-tetramethyl-4-hydroxypiperidine and succinic acid with the polycondensation product of 2,4-dichloro-6-tert-octylamino-s-triazine and 4,4′-hexamethylenebis(amino-2,2,6,6-tetramethylpiperidine);
bis(1,2,2,6,6-pentamethylpiperidin-4-yl)sebacate;
di(1,2,2,6,6-pentamethylpiperidin-4-yl) (3,5-di-tert-butyl-4-hydroxybenzyl)butylmalonate;
polycondensation product of 2,4-dichloro-6-morpholino-s-triazine and 4,4′-hexa-methylenebis(amino-2,2,6,6-tetramethylpiperidine);
polycondensation product of 2,4-dichloro-6-morpholino-s-triazine and 4,4′-hexa-methylenebis(amino-(1-methyl-2,2,6,6-tetramethylpiperidine));
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane;

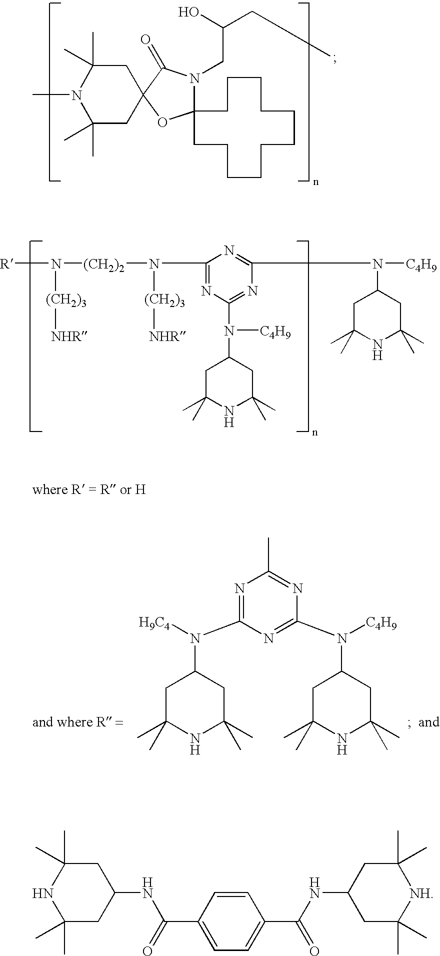

24. A fiber or filament according to claim 1 wherein the hindered amine light stabilizer is selected from the group consisting of 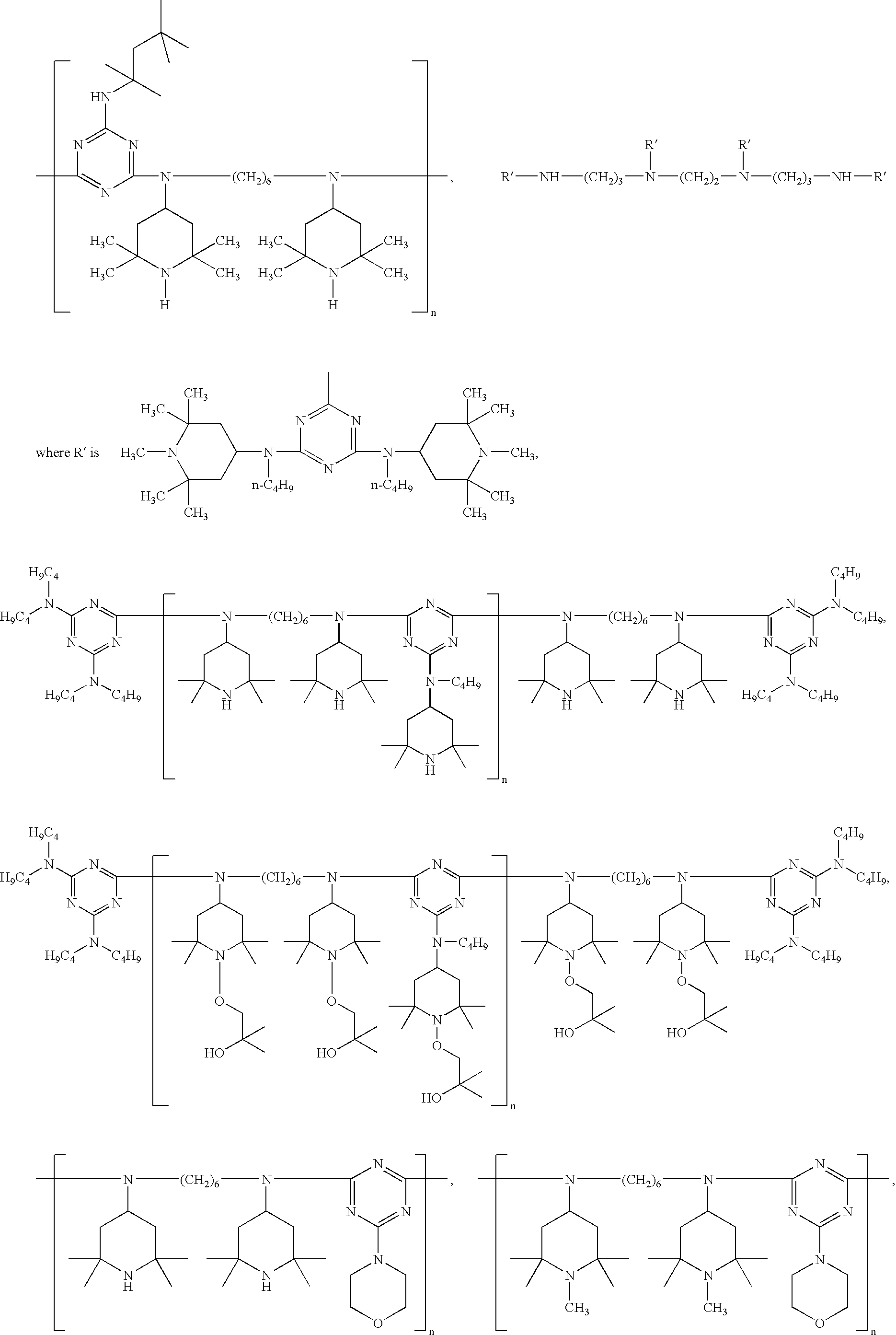 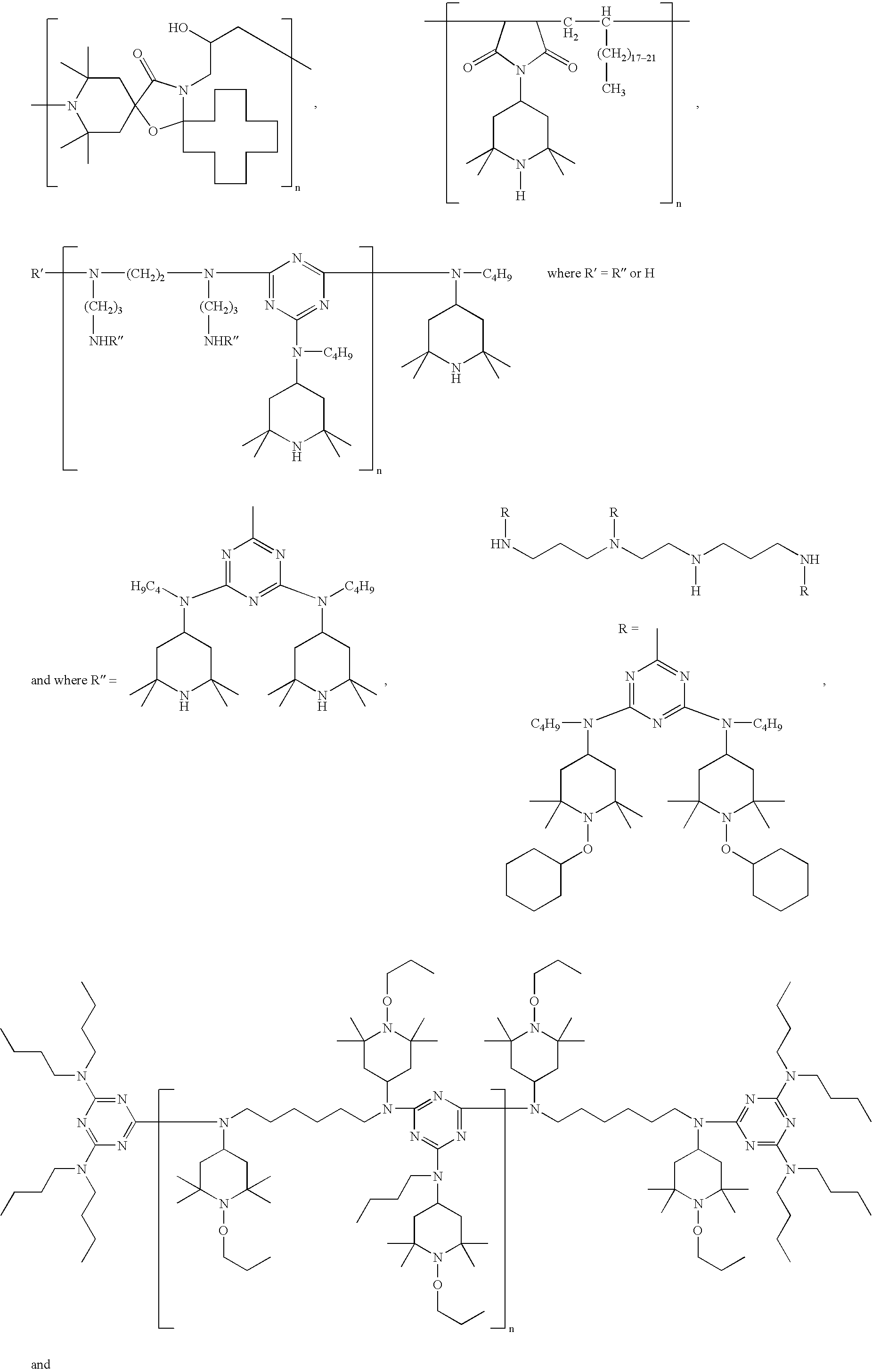 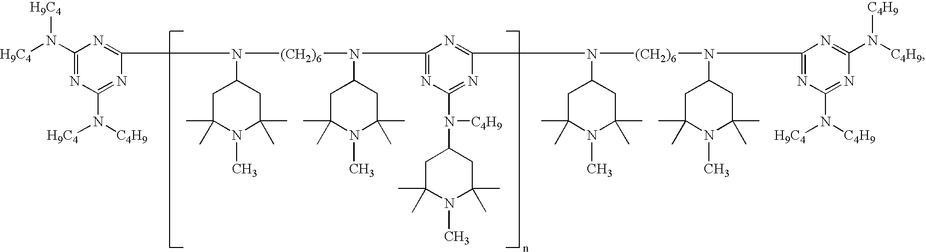
where n is an integer such that the total molecular weight of the oligomeric sterically hindered amine is above about 1000 g/mole.

25. A fiber or filament according to claim 1 wherein the hindered amine light stabilizer is selected from the group consisting of 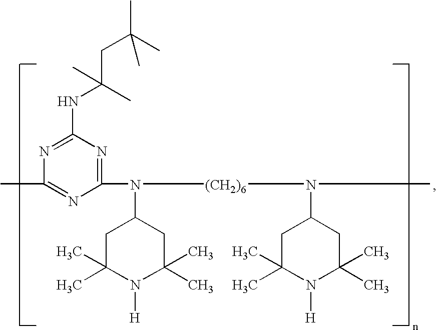
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane and 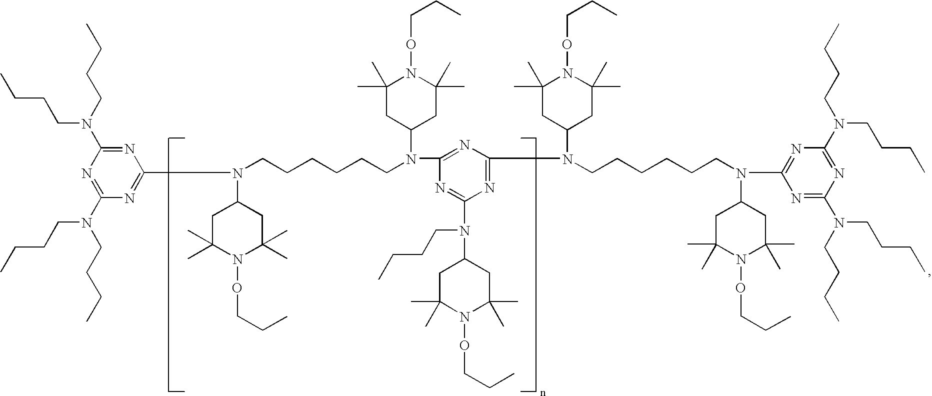
where n is an integer such that the total molecular weight of the oligomeric sterically hindered amine is above about 1000 g/mole.

26. A fiber or filament according to claim 1 wherein the ultraviolet light absorbers and the hindered amine light stabilizers, in total, are present from about 0.2% to about 0.5% by weight, based on the weight of the polyolefin.

27. A fiber or filament according to claim 1 wherein the weight:weight ratio of the ultraviolet light absorbers to the hindered amine light stabilizers is from about 1:3 to about 3:1.

28. A fiber or filament according to claim 1 wherein the dyes are selected from the group consisting of the anthraquinone blue dyes, anthraquinone red dyes, diazo red dyes and nitro yellow dyes.

29. A fiber or filament according to claim 1 wherein the dyes are selected from the group consisting of the antraquinone blue dyes, anthraquinone red dyes and the nitro yellow dyes.

30. A fiber or filament according to claim 1 wherein the dyes are anthraquinone dyes.

31. A fiber or filament according to claim 1 wherein the dyes are selected from the group consisting of Blue BLF (CI 60766, CI Disperse Blue 120, CI Disperse Blue 77), Blue GLF (CI 60767, CI Disperse Blue 27), Blue BGE-01-200 (CI 61104, CI 668210, CI Disperse Blue 60, CI Disperse Blue 99), Blue R200 (CI 63265), Blue 3RL-02 (CI 63285), Red FBN (CI Disperse Red 60), Red CB (CI 26765), Yellow GWL (CI 10338, CI Disperse Yellow 37, CI Disperse Yellow 42), Yellow CR (CI 40001, CI Direct Yellow 6) and Yellow HLG (CI 58840).

32. A fiber or filament according to claim 1 which exhibits lighffastness as measured by having a delta E at 240 hours of less than about 20 as measured according to ASTM G26.

33. A fiber or filament according to claim 1 which exhibits lighffastness as measured by having a delta E at 240 hours of less than about 15 as measured according to ASTM G26.

34. A method of preparing a dyed, light stable polyolefin fiber or filament,
which method comprises
melt blending a composition comprising
i) a polyolefin substrate,
ii) an effective amount of a combination of
at least one dyeability additive compound selected from the group consisting of the polyamides, copolyamides and polyetherpolyamides and
at least one dyeability additive compound selected from the group consisting of the ethylene vinyl acetate copolymers and
iii) an effective amount of a combination of
at least one compound selected from the group consisting of the ultraviolet light absorbers and
at least one compound selected from the group consisting of the hindered amine light stabilizers,
and which method further comprises treating said melt blend with at least one disperse dye.
